(19) United States
(12) Patent Application Publication
(10) Pub. No.: US 2017/0019454 A1
(43) Pub. Date: Jan. 19, 2017

(54) MOBILE VIDEO QUALITY PREDICTION SYSTEMS AND METHODS

(71) Applicant: King Abdulaziz City for Science and Technology, Riyadh (SA)

(72) Inventor: Hamad ALMOHAMEDH, Riyadh (SA)

(73) Assignee: King Abdulaziz City for Science and Technology, Riyadh (SA)

(21) Appl. No.: 15/211,798

(22) Filed: Jul. 15, 2016

Related U.S. Application Data
(60) Provisional application No. 62/194,030, filed on Jul. 17, 2015.

(51) Int. Cl. H04L 29/06; H04N 21/61; H04N 21/442; H04N 21/647; H04L 29/08

(52) U.S. Cl. CPC H04L 65/80; H04L 69/24; H04N 21/64738; H04L 65/608; H04L 67/36; H04N 21/44245; H04N 21/6181

(57) ABSTRACT

A method of developing a MVQP system includes determining network factors affecting video quality over a LTE network; displaying, via live video streaming, video recordings; receiving evaluations of the displayed video recordings to form a subjective assessment; calculating a subjective MOS for the video recordings based on the corresponding subjective assessment and the network factors; calculating a correlation between the received evaluations and the subjective MOS for the video recordings; receiving and saving the video recordings for an objective assessment; measuring the network factors during reception of the video recordings in the objective assessment; predicting an objective MOS for the video recordings based on the measured network factors, the calculated correlation, and at least one weight value; comparing the predicted objective MOS to the subjective MOS; and based on the comparison, modifying the weight value. The measuring, predicting, and comparing are repeated until a predetermined condition is met.

### CROSS REFERENCE TO RELATED APPLICATION

This application claims priority to U.S. Provisional No. 62/194,030 filed on Jul. 17, 2015, which is incorporated in its entirety by reference herein.

### BACKGROUND

Field of the Disclosure

Systems and methods of mobile video quality are described. In particular, the measurement, assessment, and prediction of mobile video quality for Long Term Evolution (LTE) cellular networks is described.

Description of the Related Art

The “background” description provided herein is for the purpose of generally presenting the context of the disclosure. Work of the presently named inventors, to the extent it is described in this background section, as well as aspects of the description which may not otherwise qualify as conventional art at the time of filing, are neither expressly nor impliedly admitted as conventional art against the present disclosure.

Network traffic has increased significantly with the advent of cellular technologies and widespread use of mobile phones. Mobile applications that are using more data have become popular and have congested cellular networks. Many applications, such as video-streaming apps consume both data and voice, and play a major role in an increase in the overall network traffic. Video streaming has increased as new technology continues to advance.

There is a recognized need to improve video quality to meet user expectations in terms of video resolution and speed of access. Smart devices have the technology for running high quality videos, and subscriptions to data plans enable watching the videos without interruption.

There is strong competition between network service providers in their efforts to satisfy customers by improving their cellular networks. As a result, the network service providers need to carry out video quality measurements and continuously evaluate the performance of their networks. Based on their measurements and assessments, they can make changes in various network parameters to provide better service. There is a need to evaluate the quality of video streaming at both the provider's end and the consumer's end so that effective improvements can be made.

### SUMMARY

In one embodiment, a mobile video quality prediction (MVQP) system includes a first processing circuitry configured to develop a subjective video assessment. The first processing circuitry is configured to determine network factors affecting video quality over a long term evolution (LTE) cellular network; display, via live video streaming, a plurality of video recordings; measure the network factors corresponding to each of the plurality of streamed video recordings; receive evaluations of the displayed plurality of video recordings to form a subjective assessment of each of the video recordings; calculate a subjective mean opinion score (MOS) for each of the video recordings based on the corresponding subjective assessment; and calculate a correlation between the measured network factors and the subjective MOS for each of the video recordings. The MVQP system also includes second processing circuitry configured to train the MVQP system. The second processing circuitry is configured to receive and save the plurality of video recordings; measure the network factors during reception of each of the video recordings; predict an output MOS for each of the video recordings based on the measured network factors, the calculated correlation, and at least one weight value; compare the predicted output MOS to the subjective MOS based on the subjective assessment; based on the comparison, modify the at least one weight value, and repeat the measuring, predicting, and comparing until a predetermined condition is met, The MVQP system also includes third processing circuitry configured to receive an input video recording together with network factors measured during streaming of the input video recording and output a MOS predicted for the input video recording by the MVQP system.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a video container according to an embodiment;

FIG. 2 is a block diagram illustrating an Absolute Category Rating (ACR) method according to an embodiment;

FIG. 3 is a block diagram of a stimulus presentation in the DCR method according to an embodiment;

FIG. 4 is a block diagram illustrating a Pair Comparison (PC) method according to an embodiment;

FIG. 5 is a block diagram of a reduced reference deployment system according to an embodiment;

FIG. 6 is a block diagram illustrating video quality measurement methods according to an embodiment;

FIG. 7 illustrates a multi-carrier multiple access arrangement according to an embodiment;

FIG. 8 illustrates multiple antennas used in a LTE communications network according to an embodiment;

FIG. 9 is a block diagram illustrating an overview of a network architecture according to an embodiment;

FIG. 10 illustrates a Multiplayer Perceptron (MLP) Artificial Neural Network (ANN) according to an embodiment;

FIG. 11 illustrates a Radial Basis Function (RBF) ANN according to an embodiment;

FIG. 12 illustrates MVQP divided into two phases according to an embodiment;

FIG. 13 is a block diagram illustrating a stimulus presentation in an ACR method according to an embodiment;

FIG. 14 is a block diagram of a high level design of MVQP according to an embodiment;

FIG. 15 illustrates a streaming application according to an embodiment;

FIG. 16 illustrates an exemplary display of predicting the electronic MOS of video quality according to an embodiment;

FIG. 17 illustrates each layer fully connected to the next layer in an RBF neural network according to an embodiment;

FIGS. 18A-18D are a table illustrating exemplary training sets according to an embodiment;

FIGS. 19A-19B are a table illustrating exemplary testing sets according to an embodiment;

FIG. 20 is an algorithmic flowchart illustrating implementation of MVQP according to an embodiment;

FIG. 21 is an algorithmic flowchart for a method of developing and testing a MVQP system according to an embodiment;

FIG. 22 illustrates an exemplary LTE network according to an embodiment;

FIG. 23 is a block diagram illustrating an exemplary electronic device according to an embodiment;

FIG. 24 is a block diagram of a hardware description of a computing device according to an embodiment;

FIG. 25 is a schematic diagram of a data processing system according to an embodiment;

FIG. 26 is a block diagram illustrating an implementation of a CPU according to an embodiment; and

FIG. 27 illustrates an exemplary cloud computing system according to an embodiment.

### DETAILED DESCRIPTION

Video quality depends on network factors such as frame rates, bit rates, and data packet loss. These factors make mobile video services difficult to handle, due to network bandwidth limitations and device capabilities. The success of mobile television and video services has been measured largely by a subjective quality perception of end users. An understanding of these subjective quality perceptions is necessary in order to make improvements and reach an acceptable quality level. If network service providers can fulfill user needs and expectations, the network service providers will keep existing customers and secure new customers. Some cellular companies are likely to have more users when their quality is perceived to be better and it compares favorably against other network service providers.

The field of video communication has grown rapidly in the past few years with new technologies for mobile videos. It is important to measure video quality in assessing the performance of a digital video system. Measuring the quality of a video can be implemented via a subjective assessment and/or an objective assessment.

Streaming is a term for sending data over a network. The data that is being sent has either visual or audio information, but can also contain other data as well. In video streaming, there is no need to download the data or wait until all of the data is received. The data will be processed and displayed to an end user as soon as it is received.

In adaptive streaming, the rate of data transfer will automatically change in response to a connection speed and a transfer condition. For example, if a mobile phone is unable to maintain a higher data rate, the server will lower the speed of data transfer and/or the quality of the video.

Two different types of streaming include on-demand streaming and live streaming. In on-demand streaming, a client requests to play a video and has control of the video playback. Examples of on-demand streaming include movies on demand and YouTube. In live streaming, an event is captured and streamed in real time. The end user does not have control of the video playback. Examples of live streaming include live sports and news broadcasting.

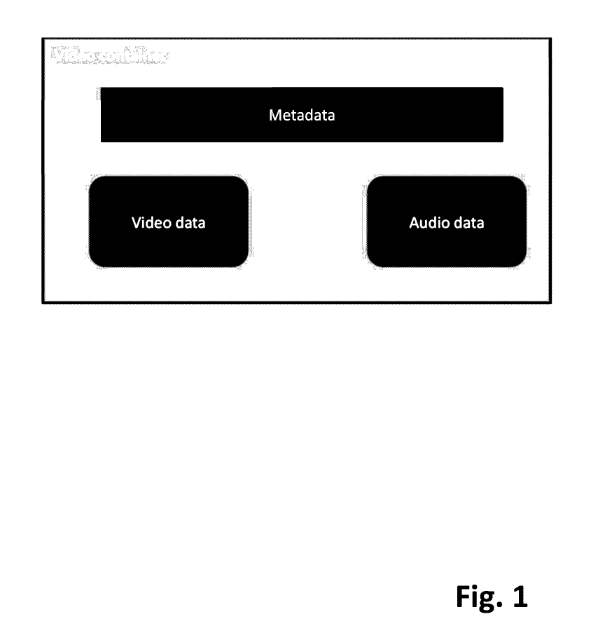

A video container or wrapper describes the structure of a media file, as illustrated in FIG. 1. There is a difference between a coder-decoder, also known as a compressor-decompressor (CODEC) and a container. CODEC is used to compress and decompress videos. Once the video is compressed, it needs to be packaged, transported, and presented. These processes are executed using a container.

Transmission Control Protocol (TCP) provides reliable transmission of data over a communications network. TCP breaks data into small packets before sending it over the communications network. On the receiving side, TCP reconstructs the data stream from the arriving packets. TCP uses a three-way handshake to make the connection, which guarantees that both sides are ready for the transmission of data.

User Datagram Protocol (UDP) is a connectionless transport-layer protocol. Unlike TCP, UDP provides unreliable transmission of data over a communications network. UDP sends packets at a constant rate. Any lost packets are not recovered. UDP is used when the reliability of the data transport is secondary to real-time requirements. Therefore, the destination must be able to cope with some loss in data. A UDP packet format contains a source, destination ports, a length, and a checksum.

Real-time Transport Protocol (RTP) defines a standard packet format for real-time data streaming over the Internet, such as audio and video. RTP provides real-time interactive audio and video, such as payload type, sequence number, and time stamping, which makes it suitable for live video streaming. RTP uses UDP as a transport protocol, so it does not guarantee delivery of the streaming data or prevent lost packet delivery.

With the increase of cellular users, the field of video quality and communication has gained in importance. Cellular network customers require higher data rates and high quality videos. The video quality measures help to define an acceptable level of quality required by users. Different methods have been proposed for the quality assessment of videos. Generally, there are two types of methods used for this purpose: subjective assessment in which humans evaluate and rate the quality of the video, and objective assessment which is a computational model between the source video and the distorted video.

Subjective assessment has been termed as a reliable process for video quality evaluation through subjective quality assessment. However, this approach is limited because of the involvement of humans in the process. After a video is viewed, the subject provides a rating on a scale ranging from 1-5, wherein 1 is the worst quality and 5 is the best quality.

ITU recommendations need to be followed before subjective assessment, since there are various factors that affect a user's attitude towards the quality of a video. The video quality depends on the user's perception and level of quality. Some of the subjective methods to measure video quality, based on ITU recommendations are given herein.

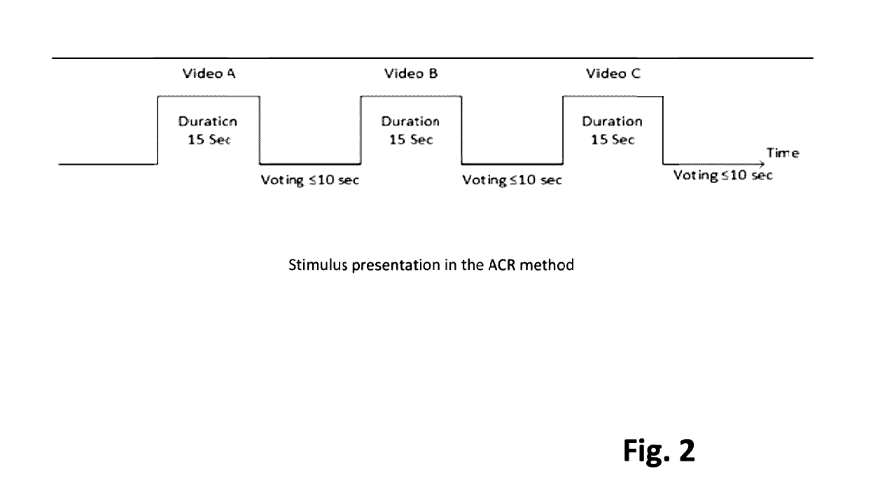

An Absolute Category Rating (ACR) method, also known as a single stimulus method, is illustrated in a block diagram of FIG. 2. This method is frequently used for the quality checking of the telecommunication services. In this method, the test sequences are presented one at a time, and they are rated independently. The viewer watches the video for about ten seconds. In the following ten seconds, the viewer rates the quality of the video.

To assess the quality of a video, a Mean Opinion Score (MOS) is calculated. The sequence in which videos are seen is important for the assessment of the quality. For example, if a video with slight impairment or degradation is viewed after a very poor quality video, the comparative analysis may give the second video a high evaluation score, as compared to a case in which the slight impairment video is seen after a high quality video. This sequence effect should be removed for proper valuation of the quality of a video. This can be accomplished by changing the sequence for each evaluator or by repeating the assessment videos in reverse order.

An Absolute Category Rating with Hidden Reference (ACR-HR) technique is a modified form of ACR. This method of estimation is widely used in the Video Quality Experts Group (VQEG), which explores methods to examine objective video quality. The evaluation results are affected by the difference in the quality of the video between the source video and the distorted video.

The evaluation results are given as:

Degradation MOS (DMOS)={Assessment Video Score}−{Reference video score}+5

An expert person in the field of video quality grades the source video as Excellent (5 rating) or Good (4 rating), for example.

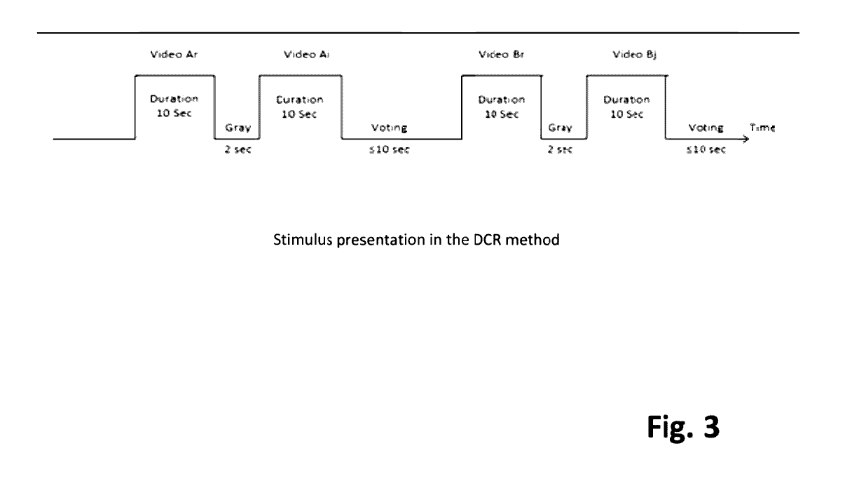

In Degradation Category Rating (DCR), also known as a double stimulus impairment scale method, a pair operation is performed, as illustrated in a block diagram of a stimulus presentation in the DCR method of FIG. 3. The pair of videos is provided as a sequence. The first video of the pair is usually the source or reference video (Video Ar, Video Br) and the second video is the same source, but a distorted video (Video Ai, Video Bj). The subject visualizes both stimuli at the same time and detects the impairments. The subject provides a rating on a scale from 1-5, for example. This method has a disadvantage in that two videos are compared in the form of a pair. Therefore, this method requires almost double the time for processing, as compared to ACR.

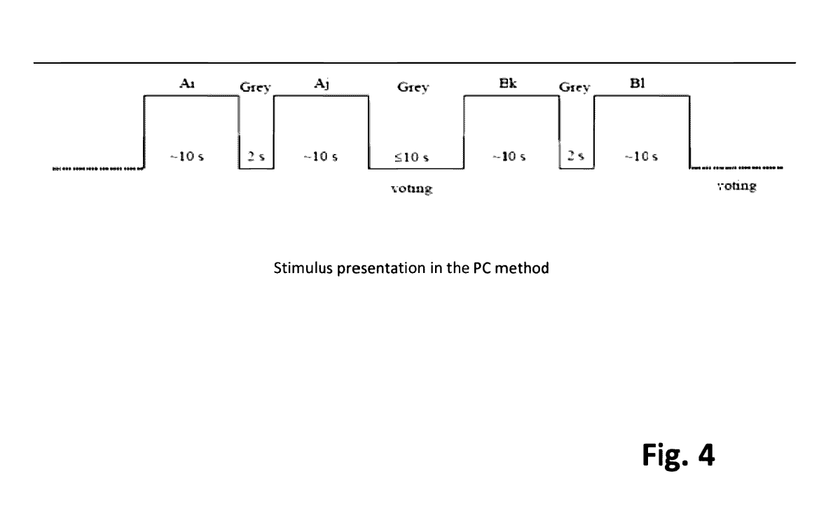

In a Pair Comparison (PC) method, pairs of videos are compared to assess their quality, as illustrated in a block diagram of FIG. 4. In this method, a set of videos is shown, one after the other and the subject chooses the video with a higher quality. If there are three sequences A, B and C, all possible combinations of these three sequences need to be made (AB, AC, BC, etc.). This means that if a sequence AB is used, its reverse BA sequence should also be used in the test. The pairs are presented for about ten seconds, depending upon the content of the sequence. Similarly, voting time is usually less than ten seconds, depending upon the mechanism used for the system.

A MOS is an average that is based on subjective opinions in a test environment. After performing subjective analysis testing, a range of integer values are given for each topic that specifies the quality ranking of what is to be observed. In standard cases, there are distribution variations of the subjective MOS, due to the differences of a subjective judgment throughout a testing procedure. There are some situations in which subjects do not provide consistent test scores. For each type of testing requirement that takes place for MOS analysis, the mean and the confidence interval of the statistical distribution of the assessment grades are calculated. For the majority of tests, it is ideal to reach a confidence level of 95%. This is the initial process for calculating the mean score.

A first step involved in calculating the MOS for each of the subjective tests is given by Equation 1.

$${\overline{u}}_{j} = \frac{1}{N} {\sum }_{i = 1}^{N} {u}_{ij} \qquad Equation 1$$

ūⱼ—mean score
i—subject
j—test condition
N—number of subjects
uᵢⱼ—score of subject i for test condition j

For each test condition to achieve a MOS, a confidence interval should be calculated, in which a value of 95% is optimal. This confidence interval is derived from a standard deviation associated with the number of subjects. To calculate the confidence interval, Equation 2 is used.

[ūⱼ−δⱼ,ūⱼ+δⱼ] Equation 2

where δⱼ is derived using the standard deviation and number of test subjects, as illustrated in Equation 3,

$${δ}_{j} = 1.96 \frac{{S}_{j}}{\sqrt{N}} \qquad Equation 3$$

and Sⱼ represents the estimated standard deviation, which is given by Equation 4.

$${S}_{j} = \sqrt{{\sum }_{i = 1}^{N} \frac{{( {\overline{u}}_{j} - {u}_{ij} )}^{2}}{N - 1}} \qquad Equation 4$$

The purpose of designing an objective assessment technique is to measure video quality with no dependency or with minimal dependency on human assessments. The type of metrics depends on the availability of the source video. Generally, there are three types of objective video quality metrics.

Full Reference

Reduced Reference

No-reference

A full reference quality metric compares the distorted video with its reference video. This method is most suitable for offline calculations, where immediate outcomes are not required but full details of the measurements of the video quality are a high priority.

A peak signal-to-noise ratio is defined as a ratio of the maximum power of a signal to the power of the noise that affects the signal. The physical difference between two signals, regardless of their contents, can be measured by using a Mean Squared Error (MSE) and the peak signal-to-noise ratio (PSNR).

MSE and PSNR can be calculated using Equation 5 and Equation 6, respectively,

$$\begin{matrix}MSE = \frac{1}{N} {\sum }_{i = 1}^{N} {( Xi - Yi )}^{2} & Equation 5 \\ PSNR = 10 {log}_{10} \frac{{( 255 )}^{2}}{MSE} & Equation 6\end{matrix}$$

where N is defined as the total number of pixels in the video. The maximum intensity value of the images is 255 and the i-^{th} pixels of the distorted and the original video are represented as Xi and Yi, respectively.

The MSE measures the difference between the two images. The PSNR on the other hand measures the closeness between two images. In either case, one of the images is always taken as uncorrupted and as a reference image, while the other image is taken as a distorted or a test sequence.

PSNR and MSE have clear physical parameters and they are easy to mathematically implement for the optimization. However, these techniques are not correlating with perceived quality measurements. Developing methods for video quality appraisal have been attempted, which consider human visual system characteristics integrated with perceptual quality measures. Recent researches on video processing have focused to develop metrics to utilize the model of a human visual system.

PSNR values greater than 37 dB are considered excellent. However, the higher value of PSNR that can be achieved represents the quality of video that is closest to the original video. Table 1 illustrates a MOS and an exemplary conversion to PSNR.

TABLE 1
MOS and Exemplary Conversion to PSNR

| PSNR[db] | MOS | QUALITY |
|---|---|---|
| >37 | 5 | Excellent |
| 31-37 | 4 | Good |
| 25-31 | 3 | Fair |
| 20-25 | 2 | Poor |
| <20 | 1 | Bad |

The structural similarity index (SSIM) is used to measure a difference between two images from a point of view of their structural information. This index has been developed to improve PSNR and MSE, as these parameters are not compatible with human eye perception. SSIM evaluates the effects of luminance on an image, the change in the contrast of the image, and any other error applicable to the image quality. Structural information can be defined in many ways. However, proposers of SSIM have classified the structural distortion as a product of independent terms. The luminance considers the similarities and differences between two images. SSIM is compatible with human perceptions and it outperforms the human visual system metric.

The SSIM between two signals x and y can be calculated by Equation 7,

$$SSIM ( x , y ) = \frac{( 2 {μ}_{x} {μ}_{y} + {C}_{1} ) ( 2 {σ}_{xy} + {C}_{2} )}{( {μ}_{x}^{2} + {μ}_{y}^{2} + {C}_{1} ) ( {σ}_{x}^{2} + {σ}_{y}^{2} + {C}_{2} )} \qquad Equation 7$$

where μₓ and μ_{y} are luminance terms and these are the mean values of x and y, respectively, σₓ² and σ_{y}² are the approximation of the contrast and these represent variances. σ_{xy} is the covariance between the two signals. C1 and C2 are constants, which are added to avoid possible division by zero, and they are selected according to Equation 8,

Cᵢ=(K,L)² Equation 8

where i=1, 2 and L is the dynamic range of pixel values, which is 255 for 8 bits/pixel. K can be selected as K₁=0.01 and K₂=0.03. It can be shown that:

SSIM (x,y)=SSIM (y,x);

SSIM (x,y)≦1; and

SSIM (x,y)=1 if x=y

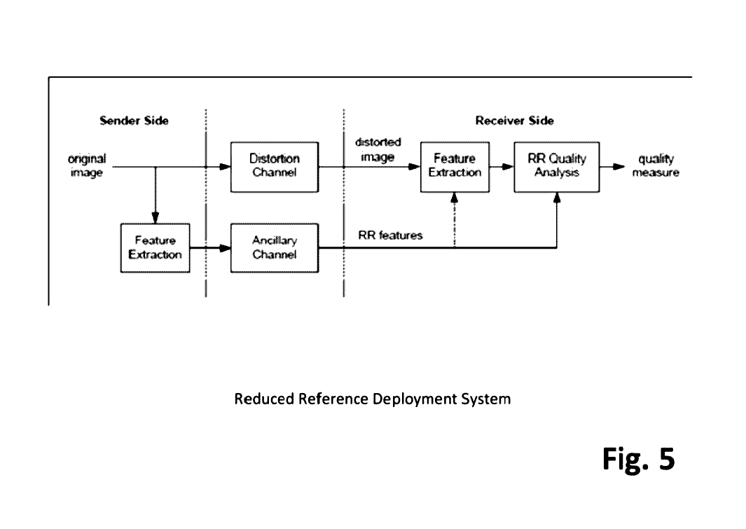

FIG. 5 is a block diagram of a reduced reference deployment system. A reduced reference deployment system measures the perceptual quality of a distorted video signal with only partial information of the reference video. Three components of a reduced reference module include the extraction of features at a sender side, the transmission of these features from the sender to a receiver side, and the extraction of the features at the receiver side to evaluate the quality of the distorted signal. The capabilities of the reduced reference metric lie between that of full reference and no-reference metrics.

The ancillary channel can be assumed to be error free, but this is not a requirement, since partly decoded reduced reference features may still be used to evaluate the quality of the distorted video. However, the accuracy may be affected.

In one embodiment, only the distorted video is available, such as a no-reference deployment system. In many applications, retrieving a reference video for the assessment is a difficult task. As a result, there is a need to develop a method that can work without the provision of a reference video. Designing such a method in real-time applications can be difficult.

Pseudo-Subjective Quality Assessment (PSQA) is a non-reference objective method that is based on a Random Neural Network (RNN) model. If a relation between these features and the subjective MOS can be developed, then MOS can be calculated by measuring these objective features. RNN is an administrative learning machine that uses a set of network factors, multimedia features, and MOS to build an estimation of the model. As a result, MOS can be predicted using the knowledge of the state of the network and multimedia features. The study of RNN is implemented to minimize the cost function that penalizes the difference between the predicted values and a real MOS subjective test's results.

A PSQA technique is a mixture of subjective and objective evaluation techniques. The objective behind this method is to evaluate several distorted samples subjectively and use the results to train a Random Neural network. The relation between the parameters that causes video distortion and MOS can be the estimated MOS.

A Hybrid Quality of Experience (HyQoE) is designed on the basis of a PSQA tool that uses RNN. A hybrid evaluation scheme is a useful tool for the analysis of QoE and the management of future wireless multimedia networks. With this objective in mind, the HyQoE, a compatible module for PSQA, is designed and estimated in a real wireless multimedia network environment.

There are four primary stages in the implementation of HyQoE.

Video quality-affecting factors

Generation of a distorted video database

Subjective quality assessments

Learning about the quality behavior through RNN

Evaluation parameters can be defined as a set of factors relevant to the quality of the service. These parameters can be used with HyQoE to differentiate between the impact levels of packet drop events and to establish a criterion to account for the network impairment, which affects the video quality. As a result, a correlation between network level impairments and user level perception can be constructed.

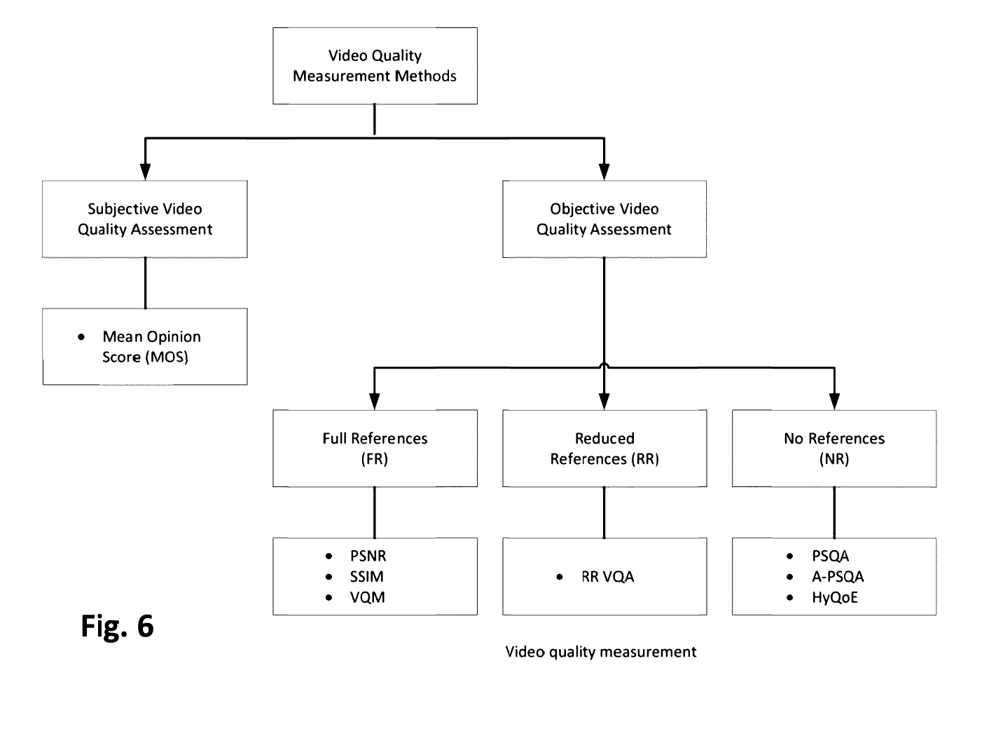

FIG. 6 is a block diagram illustrating the video quality measurement methods described herein. Subjective video quality assessment includes the MOS. Objective video quality assessment includes one or more of a full reference, a reduced reference, and no reference.

Mobile communication systems are classified on the basis of generations. The first generation (1G) was an analog mobile phone system (AMPS) introduced by Bell Laboratories in the 1980s. AMPS used separate channels for each conversation and implemented Frequency Division Multiple Access (FDMA). It operated at 850 MHz.

The second generation (2G) cellular technologies used several multiple access techniques, such as FDMA, three Time Division Multiple Access (TDMA), and Code Division Multiple Access (CDMA). These technologies replaced 1G completely and used a full duplex concept. The second generation was developed for voice communication, but it was later enhanced to transport packet data. For example, GSM transports data via General Packet Radio Services (GPRS). EDGE is a more advanced upgrade to GSM and requires more hardware and software to be added to the already-installed system.

The third generation (3G) or Wideband CDMA (WCDMA) provided fast and reliable mobile access. It provided multiple-megabit Internet access and communications that used Voice over Internet protocols (VoIP). Moreover, it had the ability to provide live music, conduct interface web sessions, and provide simultaneous voice and data access to multiple parties. 3G was able to provide 8-Mbp/s speed to transfer and stream high quality data, and it required a spectrum allocation of 5 MHz.

Key requirements for Long Term Evolution (LTE) systems were designed in the form of a Third Generation Partnership Project (3GPP). A first parameter is an achievable peak per usage data rate in which the radio communication technologies are compared. The maximum throughput per user is called peak data rate, which assumes a single user is allocated all of the available bandwidth. The target peak rates that are set for LTE release 8 are 100 Mbp/s for download link and 50 Mbp/s for uplink, within a bandwidth of 20 MHz. In practically implemented situations, individual users may be located at varying distances from the base stations and as a result, may experience different channel conditions.

Due to the signal propagation conditions, the particular individuals may not get the maximum download and upload rates. As a result, the promised peak rate of a system is usually not achievable, so it is rare that a single user is experiencing continuous high peak data rate for a continuous time. However, many applications and services usually do not require a high level of performance and peak data rates.

Performance is an important consideration and it is directly related to the number of cell sites that a cellular network operator requires for its efficient operation. LTE systems are designed to provide real-time communications, even if the user equipment (UE) is moving at speeds of up to 500 km/h. As a result, the handover between cells needs to be made as quickly as possible without any delay, loss of data packet, or interruption. Otherwise, the call may be dropped.

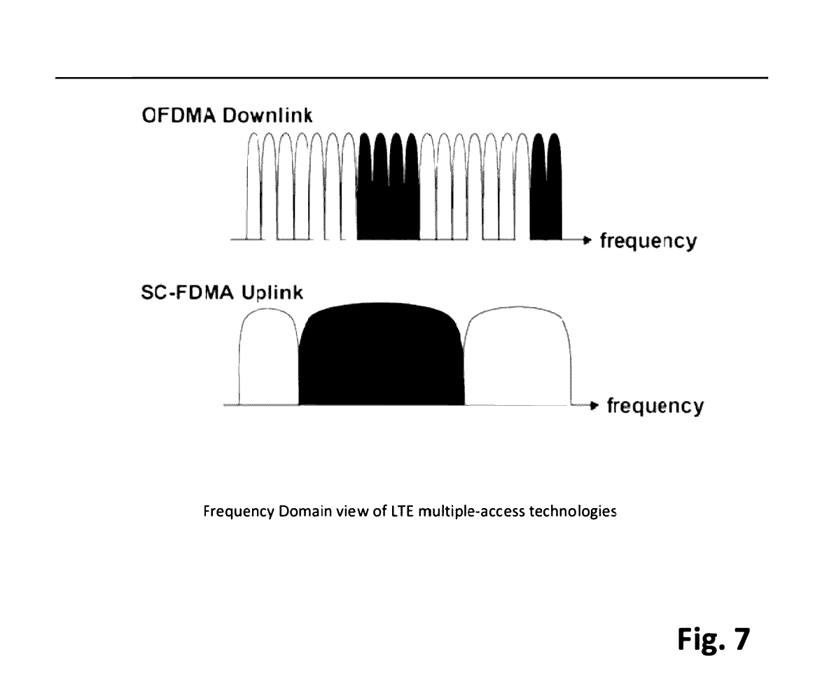

LTE adopts a multi-carrier multiple access arrangement, wherein Orthogonal Frequency-Division Multiple Access (OFDMA) was selected for downlink and Single Carrier Frequency Division Multiple Access (SC-FDMA) was selected for uplink, as illustrated in FIG. 7. OFDMA divides the total available bandwidth into many narrow bands that are arranged orthogonal and can carry on independent transmissions without interfering with each other.

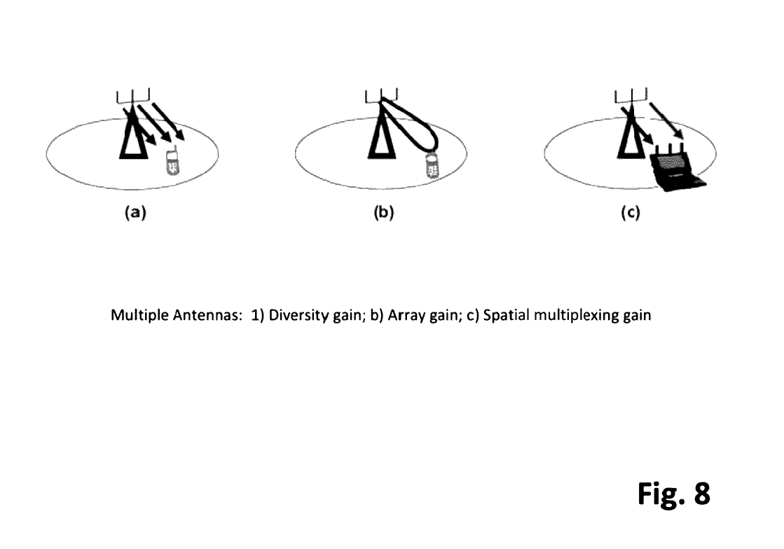

LTE provides a practical example of the use of multiple antenna technology. The use of multiple antennas allows exploitation of the spatial domain in a way that is necessary in the quest for higher spectral efficiencies. Multiple antennas can be used in many ways, mainly based on three fundamental principles, as illustrated in FIG. 8.

Diversity gain: reduces the multipath fading of the transmission

Array gain: concentrates energy in one or more given particular directions

Spatial multiplexing gain: sends multiple data to a single user simultaneously, which can be accomplished by a combination of different transmitting antennas

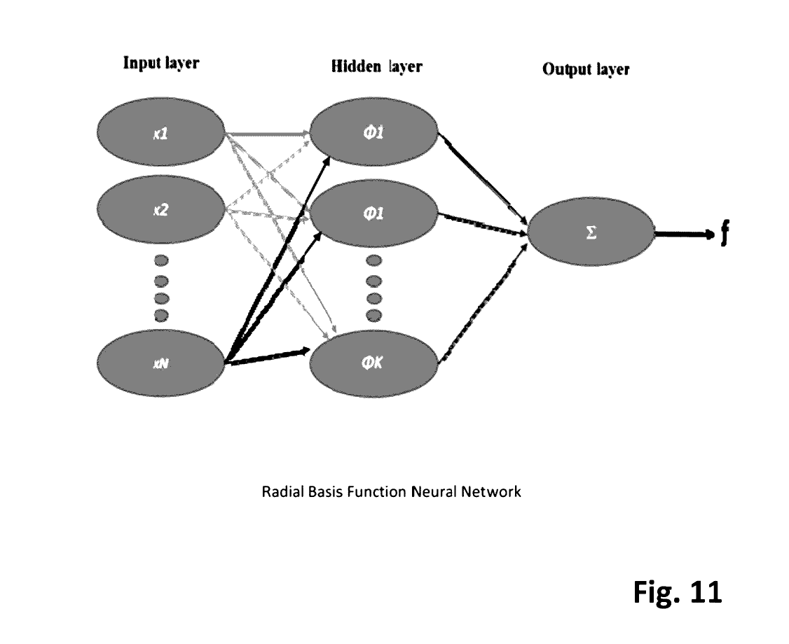

LTE is designed on the basis of Packet Switched (PS) services. A basic objective of LTE is to provide uninterrupted Internet Protocol (IP) connectivity between the UE and Packet Data Network (PDN). In addition to the evolution and development of radio and wireless aspects of LTE, such as Enhanced Universal Mobile Telecommunication System Terrestrial Radio Access Network (E-UTRAN), the non-radio aspects of LTE were also developed, such as System Architecture Evolution (SAE). FIG. 11 is a block diagram illustrating an overview of a network architecture.

A Core Network (CN) known as an Evolved Packet Core (EPC) in SAE is responsible for complete control over a UE and establishing the bearers. The CN contains the following logical nodes.

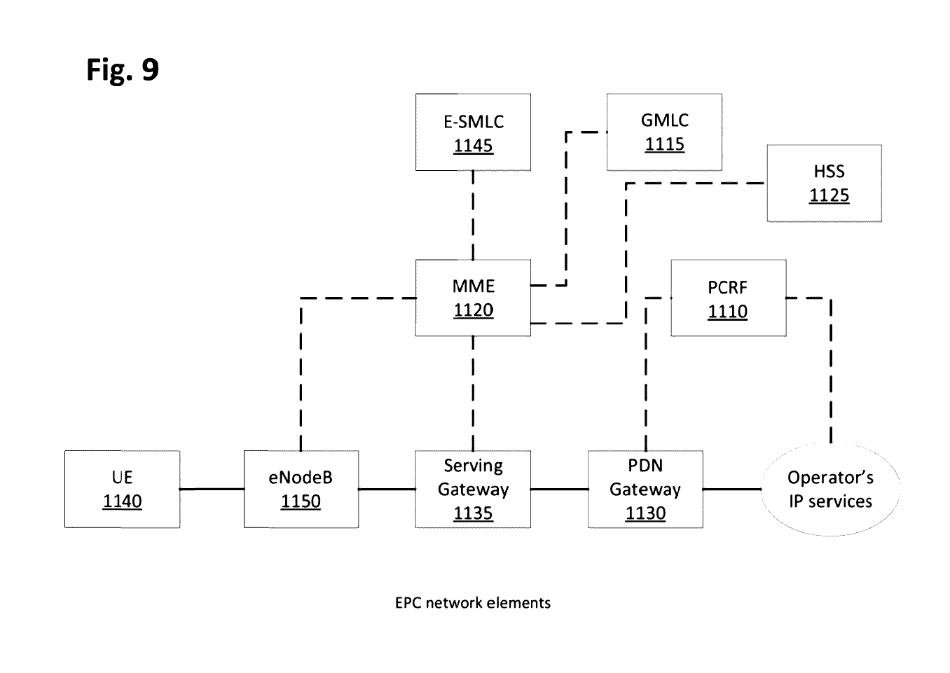

In FIG. 9, a Policy and Charging Rules Function (PCRF) 1110 is responsible to make and control the decision and to control the charging functionalities. It also authorizes QoS to decide how certain data will flow and enforce minimum QoS.

A Gateway Mobile Location Center (GMLC) 1115 contains the functionalities required to control Location Services (LCS) to obtain user location information. After becoming authorized, the GMLC forwards the positioning requests to Mobility Management Entity (MME) 1120 and receives the final location.

A Home Subscriber Server (HSS) 1125 contains the cellular network user's subscription information, such as user identification and user profile information. HSS 1125 authenticates and manages the subscriber information and passes the information to MME 1120.

A Packet Data Network Gateway (PDN-GW) 1130 is responsible for the IP allocation to the UE. It is also responsible for the policy enforcement and packet filtering for each subscriber. In addition, it also serves as the central mobile connecter for interworking with non-3GPP technologies, such as the Worldwide Interoperability for Microwave Access (WiMAX) and CDMA2000 or 3G technologies by different vendors.

A Serving Gateway (S-GW) 1135 routes and transmits the data packets to a user. It also manages and stores UE 1140 settings and it collects data from the EPS bearers, specifically when the UE 1140 is not active and is in idle state.

The MME 1120 is the main control node between the UE 1140 and the CN. It also manages the network resources and UE mobility, such as roaming and handovers. In addition, MME 1120 authenticates and handles a mobile device.

An Evolved Serving Mobile Location Centre (E-SMLC) 1145 manages the overall coordination and scheduling of resources required to determine the final location of UE 1140 that is attached to E-UTRAN. It also calculates the location and estimates the speed of the UE 1140 and the location accuracy.

Before sending the IP packets to a UE 1140, the IP packets are wrapped in an EPC protocol. After enclosing the IP packets in the EPC protocol, they are tunneled in between the PDN-GW 1130 and Evolved Node Bs (eNodeBs) 1150. For the tunneling process, different additional protocols are used. When the central control nodes are not present, data is protected during the process of handover. This task is performed by Packet Data Convergence Protocol (PDCP) layer.

LTE is capable of providing high definition live streaming with little or no noticeable delay, due to a high bandwidth capability. There are two types of videos used over a cellular network. One type of video is called video-on-demand (VoD), wherein the cellular subscriber is the viewer. Heavy traffic comes from a base station to subscribers through a downlink. In an uplink, the cellular subscriber feeds streaming video live to the network. In an uplink, the heavy traffic is going from the cellular subscriber to the cellular base station.

Various types of networks can be formed, which use LTE as a foundation. In computer science, an Artificial Neural Network (ANN) can be considered an algorithm, whose design is based on the human brain. Two important properties of the human brain are learning from experience and evolution. The property of evolution helps not only to remember, but also to reconstruct new things. An ANN is capable of providing an output when fed with different inputs. In many applications, an ANN performs similar functions as the brain, such as pattern recognition. For example, a neural network for a vehicle's license plate recognition is a set of artificial neurons that are activated by the pixels of an input image from the vehicle's plate. The image is then processed and the ANN predicts the vehicle's plate number.

Training an ANN can be accomplished by supervised learning or unsupervised learning. Supervised learning is called classification, wherein both input and output are provided. The ANN is trained by using a set of training data. During its training, an ANN learns how to associate the input vectors with the desired output vectors. After the training is completed, the ANN should be able to recognize a pattern and predict an output when presented with a new and unseen input vector.

Unsupervised learning is called clustering, wherein training data includes example vectors at input, without any corresponding desired result at the output. As input vectors are presented at input neurons, the input vectors are divided into an integer number of groups, wherein a group may be previously specified or it may also be allowed to grow in accordance with the data diversity. When the cluster is formed, another ANN can be trained in order to associate each cluster with the desired output. An overall system becomes a classifier in which the first network is unsupervised and the next network is supervised. An important application of clustering is data compression, which is widely used in data mining for the purpose of finding patterns in large complex data.

A neuron is referred to as a node. A node may have many connections to other nodes on an input layer and an output layer. Each input to a node is multiplied by its associated weight. The main role of a node is to sum each of its weighted inputs and add a bias term to form the activation. Each node passes this activation through a nonlinear activation function. The behavior of any ANN is dependent upon the weights, bias terms, activation function, and its topology.

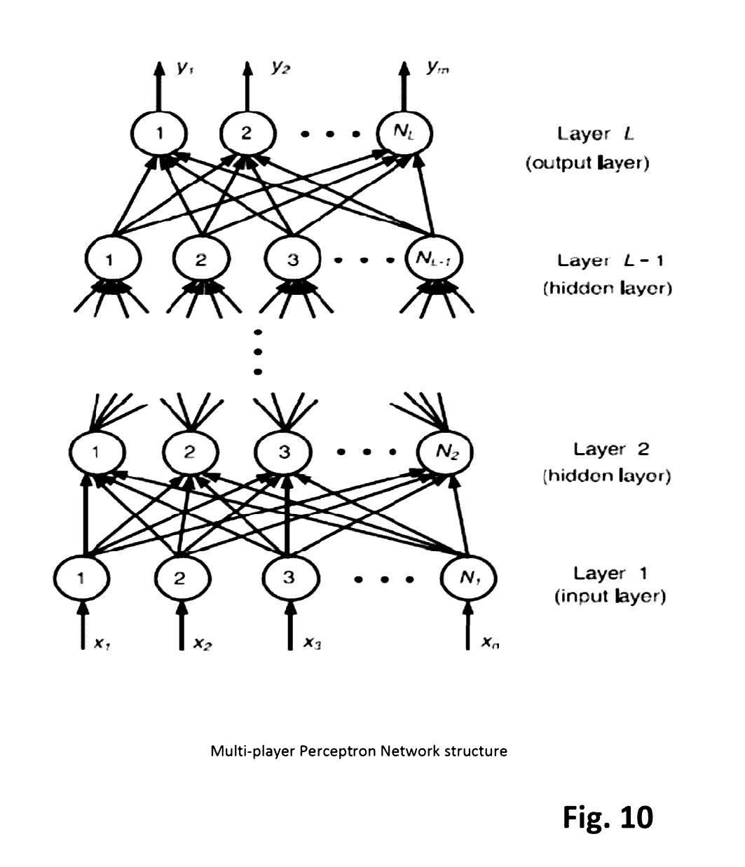

A Multiplayer Perceptron (MLP) is a popular type of ANN. A MLP belongs to a general class of networks, usually referred to as feed-forward networks. The structure of MLP consists of multiple layers, which include an input layer, a hidden layer, and an output layer, as illustrated in FIG. 10. Each layer is fully connected to the next layer. The input layer connects to the hidden layer and the hidden layer is connected to the output layer. In the simplest case, a MLP network consists of single input and output layers and multiple layers of hidden neurons.

A common activation function that is used in MLP is a sigmoid function, which it is presented mathematically in Equation 9.

$$Sigmoid function σ ( γ ) = \frac{1}{( 1 + {e}^{- γ} )} \qquad Equation 9$$

Another commonly used activation function is the arc tan function and the tan function. Equation 10 illustrates their mathematical relationship.

$$Tan function σ ( γ ) = ( \frac{2}{π} ) arctan ( γ ) \qquad Equation 10$$

In a feedforward process, the input is fed to the first layer of neurons. The output of this layer becomes the input for the second layer, which continues until the last layer provides the output. During the process of feedforward computation, the weights remain fixed.

Radial Basis Function (RBF) ANNs are based on the theory of function approximation. They use Gaussian transfer functions in the hidden layer neurons, and their outputs are inversely proportional to the distance from a center of the neuron. A model of a RBF is illustrated in FIG. 11. There are three layers in a RBF ANN, which are the input layer, the RBF layer, and the output layer. A linear combination of scalar quantities and an input vector is provided as input to the hidden layer. A unity value is assigned to the scalar quantities. The input is given by Equation 11.

X=[x₁,x₂,x₃, . . . ,xₙ]^{T} Equation 11

The entire input applies to each neuron in the hidden layer. The incoming vectors are mapped by the RBFs in each hidden node. The output is illustrated in Equation 12.

y=[y₁,y₂,y₃, . . . ,yₘ] Equation 12

The output is obtained by Equation 13.

$$y = f ( X ) = {\sum }_{i = 1}^{k} {w}_{i} {φ}_{i} ( X ) \qquad Equation 13$$

In this formula, f(X) is the final stage output and φᵢ(.) denotes the RBF of the i-th node, wᵢ denotes the weight hidden to output with respect to the i-th node, and k is the number of total hidden nodes. The output of a single RBF ANN is illustrated in FIG. 11.

The data processing flow in both MLP and RBF is one direction. Both of these networks are of the feedforward type. The difference between MLP and RBF is usually in the hidden layer. The hidden layers of MLP and RBF ANNs use different activation functions. MLP can also have more than one hidden layer, whereas the RBF can have only one hidden layer.

Embodiments herein describe systems and methods for predicting video streaming quality related to mobile devices over UDP through a LTE cellular network. A Mobile Video Quality Prediction (MVQP) algorithm described herein measures cellular network parameters using a mobile device, such as a smart phone.

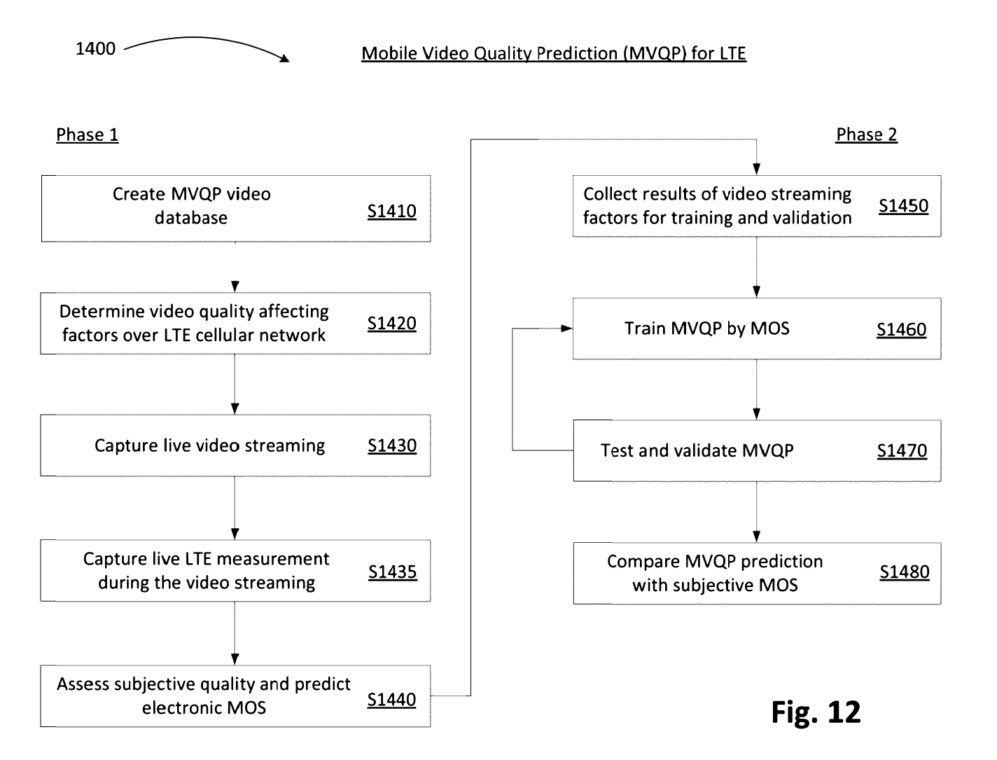

MVQP is divided into two phases as illustrated in FIG. 12. MVQP uses subjective assessments from observer ratings to calibrate a mapping between a set of objective engineering measurements and subjective QoE measurements. The first phase of MVQP develops a raw video database and a set of factors that affect video quality. The second phase collects quality results of the video streaming factors to train and validate a MVQP algorithm to form an automatic prediction of a user experience.

In the first phase of MVQP, a MVQP video database is created in step S1410. The MVQP video database includes videos containing different attributes, such as motion, content, and type of shot. Multiple types of video shots are utilized to create an extensive video database, such as panoramic shots, tilt shots, tracking shots, and zooming shots. The video clips can also be taken at multiple resolution levels, such as 2000 or 4000 pixels per inch (ppi).

Video quality over the LTE network is dependent upon several contributing factors. In step S1420, factors that affect video quality over a LTE cellular network are determined. Some of the key factors that affect streaming video quality are described herein.

A Reference Signal Strength Indicator (RSSI) is the total power received within the LTE channel expressed in dBm. RSSI is a combination of the signals received from all sources, including the power from a serving cell, a non-serving cell, a co-channel, and an adjacent channel interference.

A Reference Signal Received Power (RSRP) is a received reference signal averaged across all resource elements which contain the reference signal. The RSRP helps determine the serving cell for initial random access or LTE handover. The RSRP value ranges from −40 to −44 dBm.

A Reference Signal Receive Quality (RSRQ) is a principle measure of a LTE signal quality. RSRQ is dependent on both RSSI and RSRP and can be calculated by using Equation 14, where N is the number of resource blocks (RBs) used for RSSI.

$$RSRQ = N \frac{RSRP}{RSSI} . \qquad Equation 14$$

Data communication takes place in the form of packets. Packet loss results when packets fail to reach the desired destination. As such, the packet loss represents a fundamental measure of the quality for a data communication link. In LTE networks, the packet loss is related to factors such as RSSI, RSRP and RSRQ.

In step S1430, live video streaming is captured. In an example, given for illustrative purposes only, 16-bit raw image formatted data can be captured at a resolution of 4000 ppi. The 4000 ppi resolution preserves more tonal values than that differentiated by a human eye. Video recordings can be captured at a rate of 29.97 frames per second in various selected locations. Random locations can be used in which RSSI levels range from −87 dBm to −51 dBm. For each location, live streaming can be implemented over the UDP protocol. A variety of locales can be selected to capture a wide range of video variables, such as motion, lighting, color, etc. However, other parameters for capturing streaming raw videos are contemplated by embodiments described herein.

In step S1435, parameters from the live video streaming are measured. A MVQP measurement application measures and saves radio frequency (RF) signals each second. The MVQP measurement application saves the values of the parameters such as RSSI, RSRP and RSRQ at each instant for later use and analysis.

Results have shown a direct correlation between the values of RSSI, RSRP, and RSRQ and the percentage of total packet loss for videos captured at various locations. When RSSI, RSRP, and RSRQ decreased, results showed an increase in packet loss. Therefore, video quality can be based at least in part, on the total percentage of packet loss.

In step S1440, a subjective mobile video quality assessment is made from evaluating a plurality of videos streamed live from different locations. The locations can be selected on the strength of the LTE signal over the LTE cellular network. The streamed videos can be saved in one or more mobile devices, such as laptop devices.

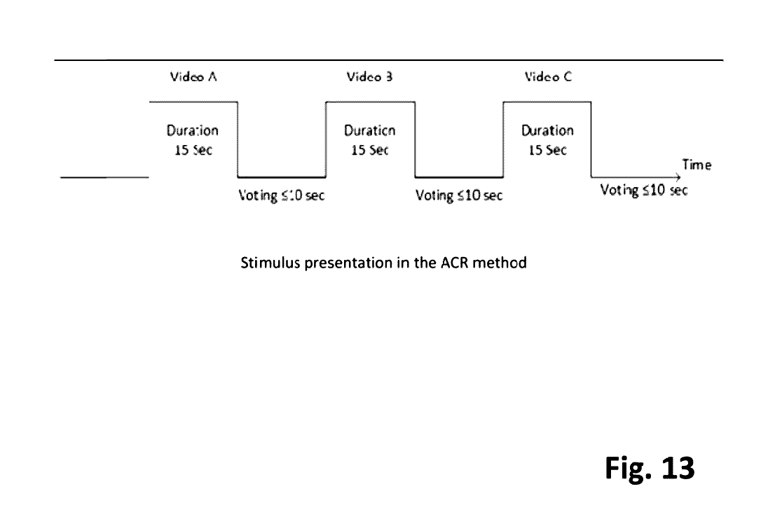

The subjective assessment can be based on the ACR method. The ACR method presents test sequences one at a time to viewers who rate each one independently. The viewer watches a video for about fifteen seconds and within the next ten seconds, rates the quality of the video on a scale of 1 to 5, for example. FIG. 13 is a block diagram illustrating a stimulus presentation in the ACR method. However, other testing parameters are contemplated by embodiments described herein.

A first step in evaluating results of the subjective assessment is to calculate the MOS for each of the subjective tests by Equation 15.

$${\overline{u}}_{j} = \frac{1}{N} {\sum }_{i = 1}^{N} {u}_{ij} \qquad Equation 15$$

ūⱼ—mean score
i—subject
j—test condition
N—number of subjects
uᵢⱼ—score of subject i for test condition j

For each test condition, a confidence interval can be calculated. The confidence interval can be derived from a standard deviation associated with the number of subjects. Equation 16 can be used to calculate a 95% confidence interval,

[ūⱼ−δⱼ,ūⱼ+δⱼ] Equation 16

where δⱼ is derived using the standard deviation and number of test subjects in Equation 17, and

$${δ}_{j} = 1.96 \frac{{S}_{j}}{\sqrt{N}} \qquad Equation 17$$

where Sⱼ represents the estimated standard deviation and is given by Equation 18.

$${S}_{j} = \sqrt{{\sum }_{i = 1}^{N} \frac{{( {\overline{u}}_{j} - {u}_{ij} )}^{2}}{N - 1}} \qquad Equation 18$$

In subjective assessments that were conducted, results showed the amount of consistency and correlation between packet loss and MOS. As expected, packet loss and MOS are found to be inversely proportional to each other. Study results also showed that a small percentage packet loss can have a major impact on video quality. When packet loss increases, MOS decreases.

The first phase of MVQP uses subjective assessments from observer ratings to calibrate a mapping between a set of objective engineering measurements and subjective QoE measurements. Results showed a high consistency and correlation between the RSSI, RSRP, RSRQ, lost packets, and MOS.

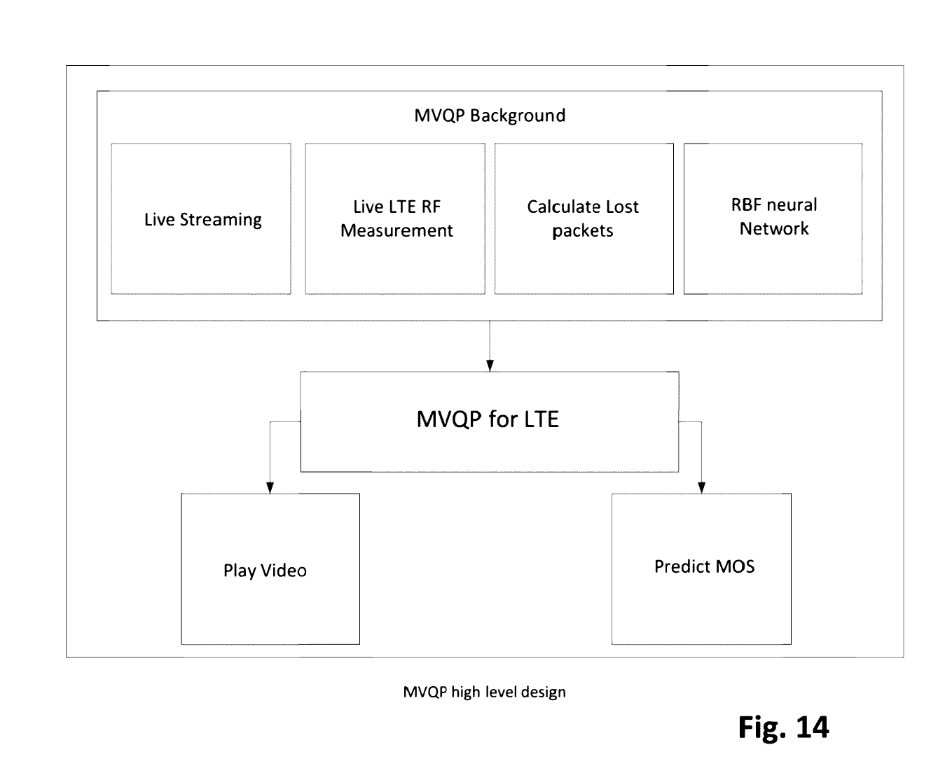

With reference back to FIG. 12, phase two begins with developing a MVQP system and method in step S1450. The second phase collects quality results of the video streaming factors to train and validate a MVQP algorithm to form an automatic prediction of a user experience. FIG. 14 is a block diagram of a high level design of MVQP. The MVQP algorithm receives the input factors of RSSI, RSRP, RSRQ, and lost packets to predict an output MOS. The input factor measurements start when the video streaming starts and records any changes in RSSI, RSRP, and RSRQ. The measurements are run in the MVQP background while the streaming runs in the foreground. At the completion of video streaming, the lost packets and the average of LTE parameters are calculated. The MOS is predicted using the RBF ANN.

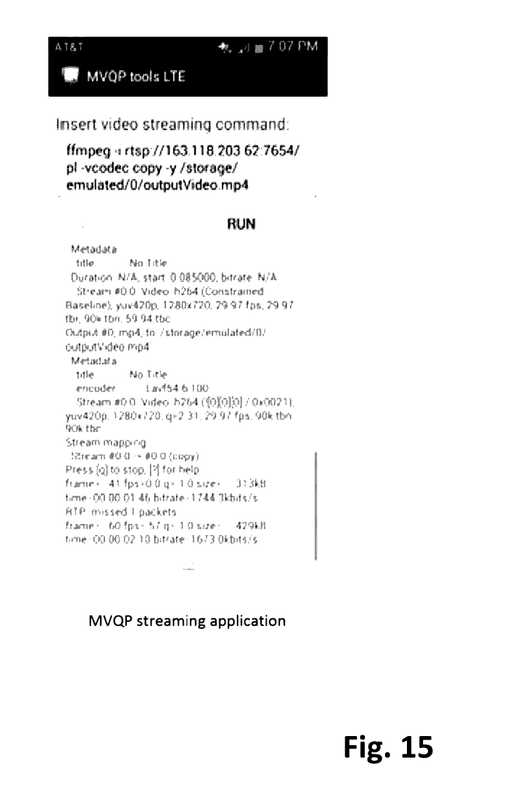

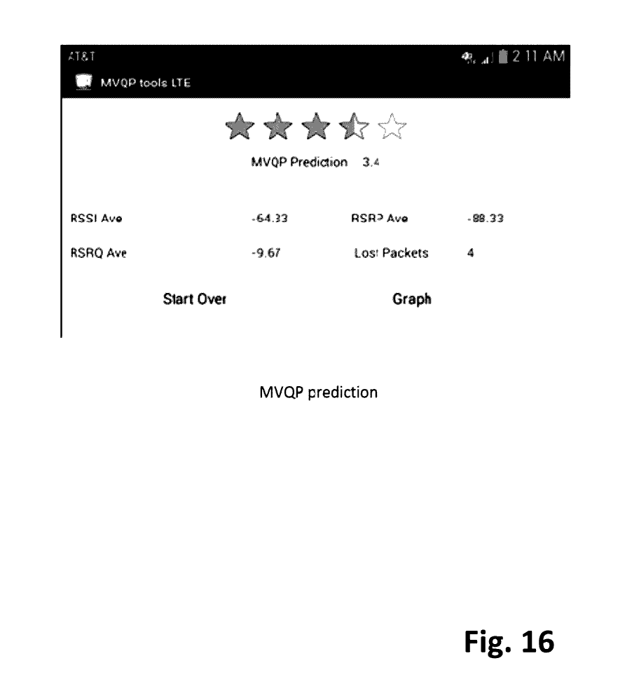

A MVQP algorithm is configured with processing circuitry to perform the following functions.
Receive streaming video from the server via a library, such as a FFMPEG library. The streamed videos are received and saved through the cellular network, as illustrated in a streaming application of FIG. 15;
Play a received video in a mobile device, such as a smart phone;
Record the RF measurements during the streaming process and graph the cellular network parameters;
Calculate the lost packets during the streaming process; and
Predict the electronic MOS of video quality, as illustrated in an exemplary display of FIG. 16.

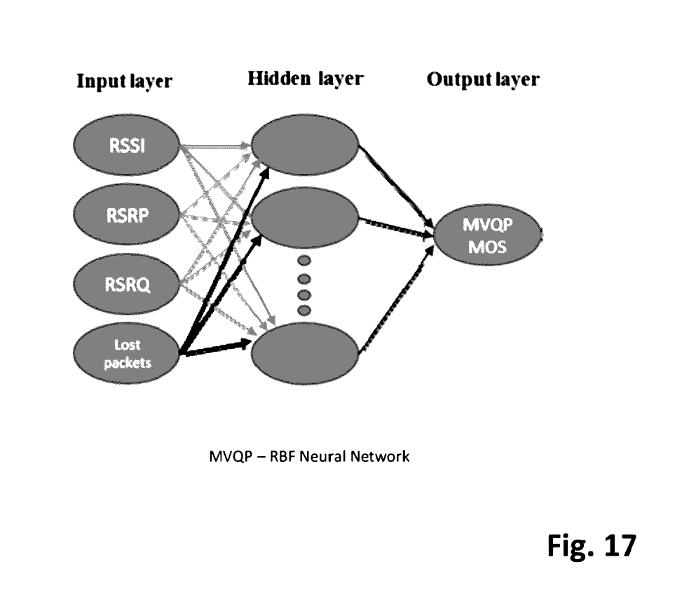

The MVQP for LTE can use a RBF ANN for prediction. It has three layers of an input layer, a hidden layer, and an output layer. Each layer is fully connected to the next layer, as illustrated in FIG. 17. The hidden layer includes nonlinearly-activating nodes and the output layer includes linearly-activating nodes. A Gaussian activation function can be used to calculate the nodes on the hidden layer. For the output layer, a gradient reduction algorithm can be used to calculate the weights.

The following algorithm can be used to implement MVQP.
1. Read inputs and target output from an external source, such as a text file
2. Initialize network parameters, i.e. the number of neurons in the three layers of the RBF the learning rate (η), the stop condition error threshold, and the number of training cycles (epochs)
3. Initialize the centers and the radius of each neuron
4. Initialize the weights to a random number within the range [−1,1]
5. For each iteration in a training cycle, perform the following steps:
   a. Choose a random data set from the training set
   b. Calculate the output of the hidden layer as:

$$hiddenOutput = exp ( - \frac{\vert \vert input - center {\vert \vert}^{2}}{2 * {radius}^{2}} )$$

c. Calculate the output of the network as:

predictedOutput=bias+ΣhiddenOutput*weight
where a bias is a value associated with each node to allow a shift in the activation function to the right or to the left
d. Calculate the error as:

error=targetOutput−predictedOutput
e. Adjust the hidden output weight as:

newWeight=previousWeight−(η*error*hiddenOutput)
f. Calculate the average error
6. Repeat step 5 until a maximum number of training cycles is reached or an average error is reduced to a desired number.

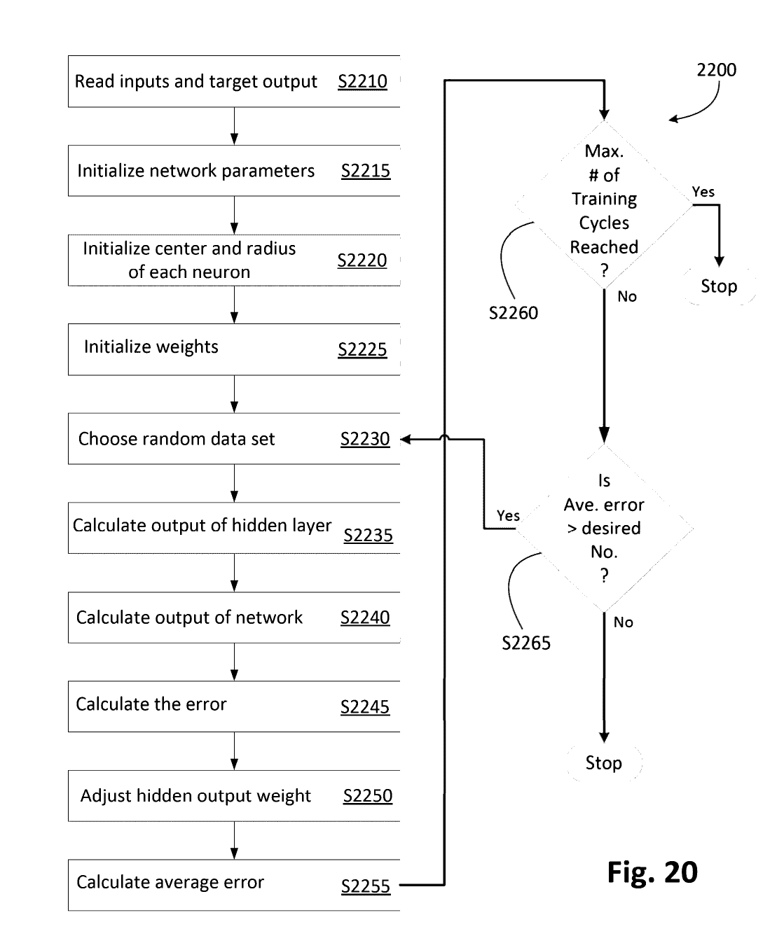

A flowchart of the algorithm used to implement MVQP will be described in more detail herein with reference to FIG. 20.

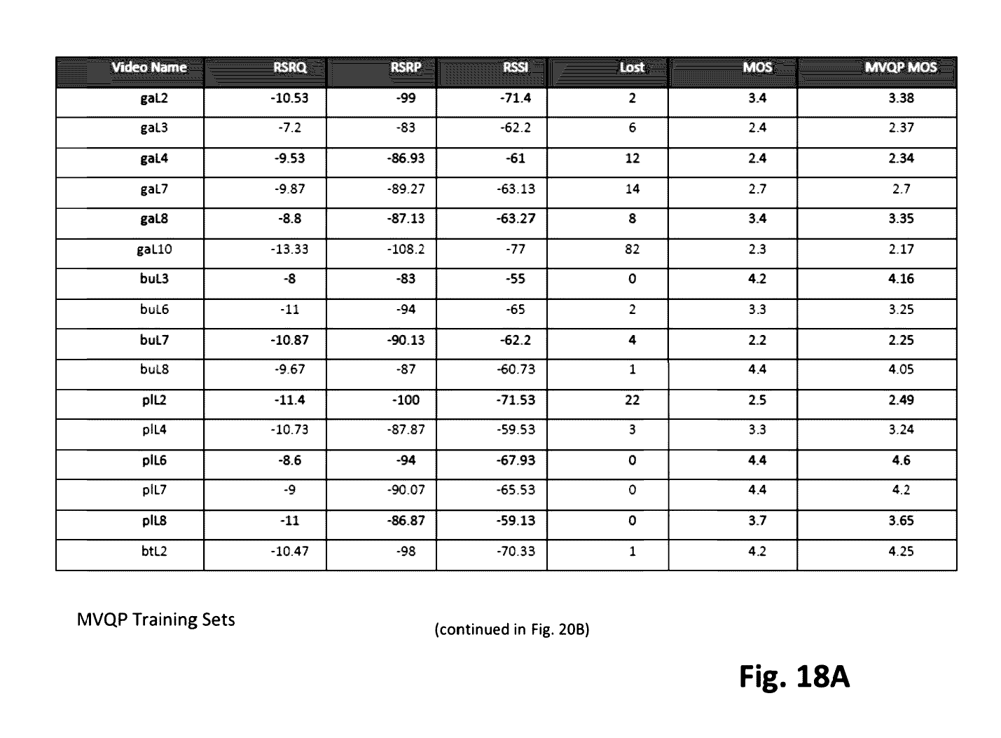

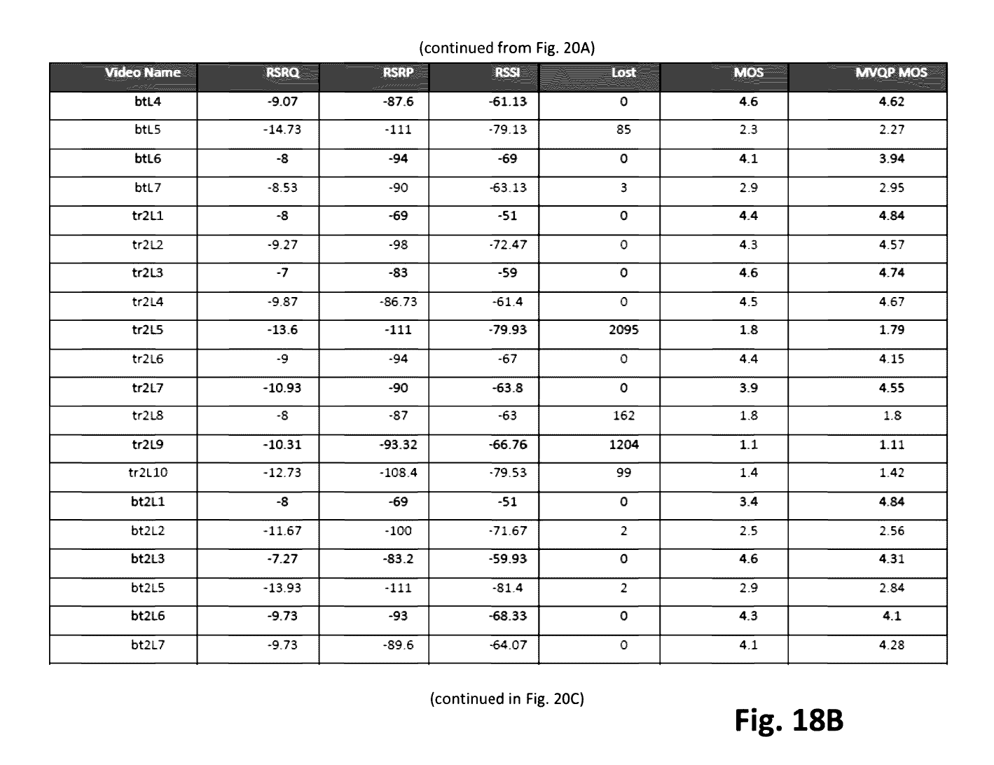

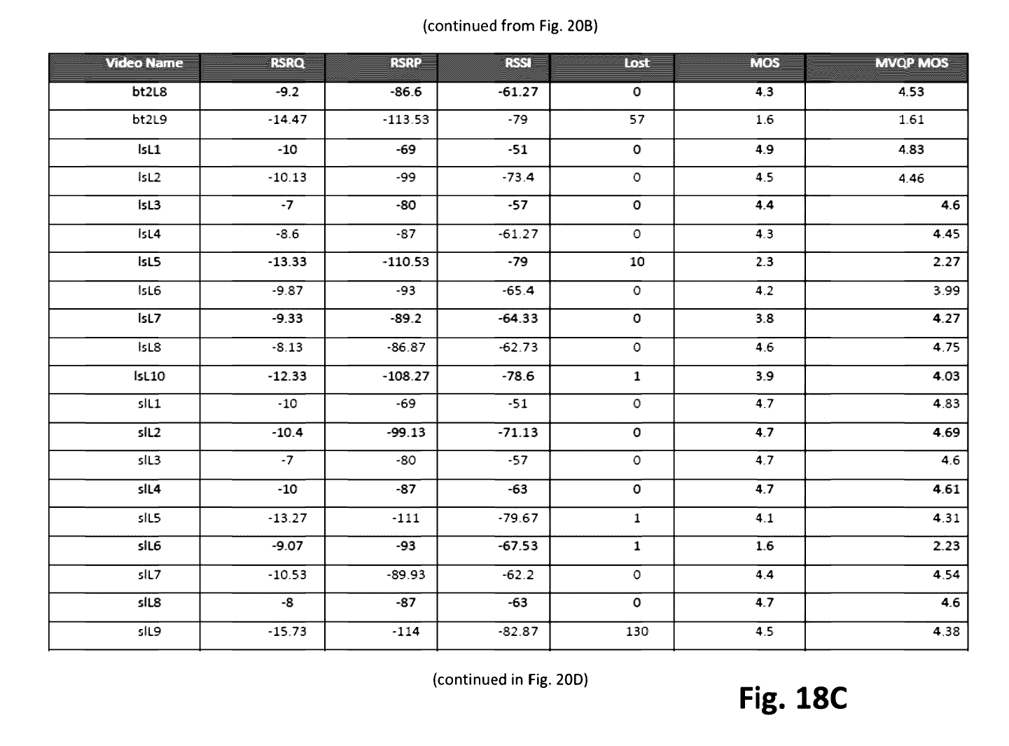

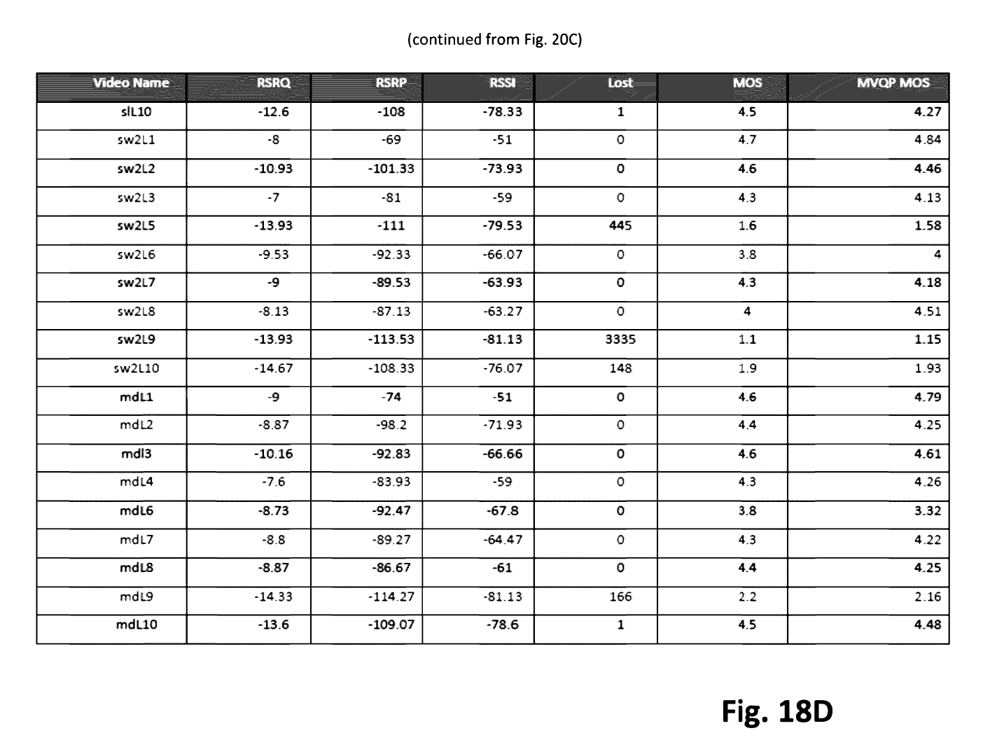

With reference back to FIG. 12, the MVQP is trained in step S1460. During the RBF training process, a set of input factors corresponding to their output values are provided in the learning process. The input factors are fed to the input layer and the MVQP-MOS is predicted at the output layer. For each neuron, the error is calculated. The average error is reduced by adjusting the weights and biases. When the average error reaches the acceptable rate, the MVQP stops the training process. FIGS. 18A-18D are a table illustrating exemplary training sets that could be used to train the MVQP.

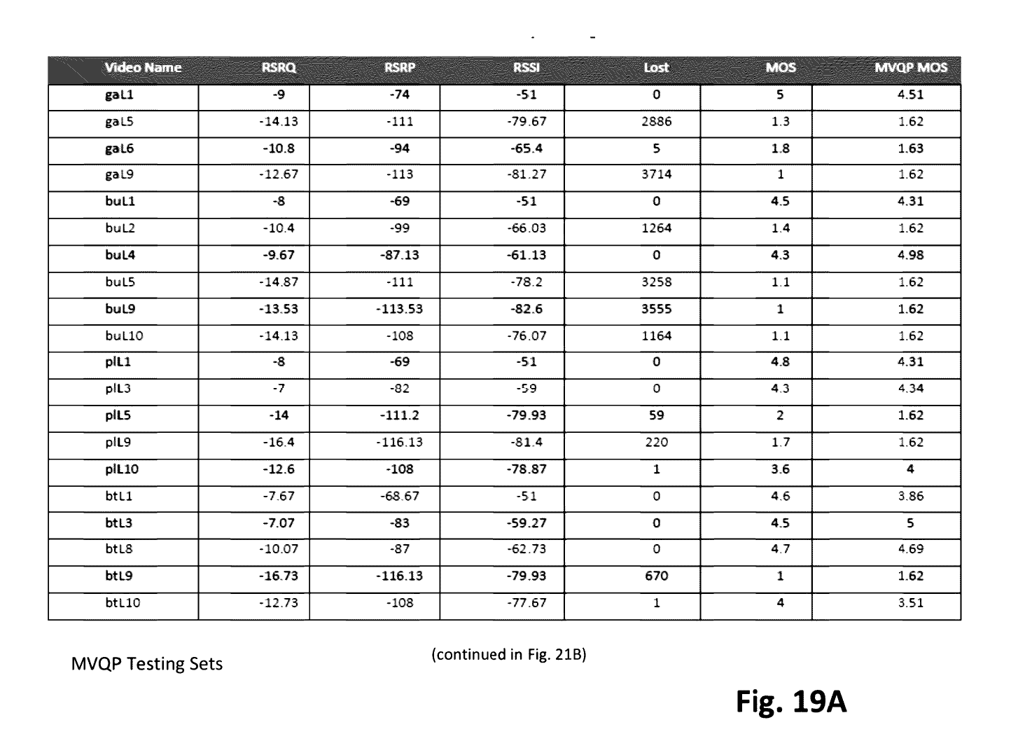

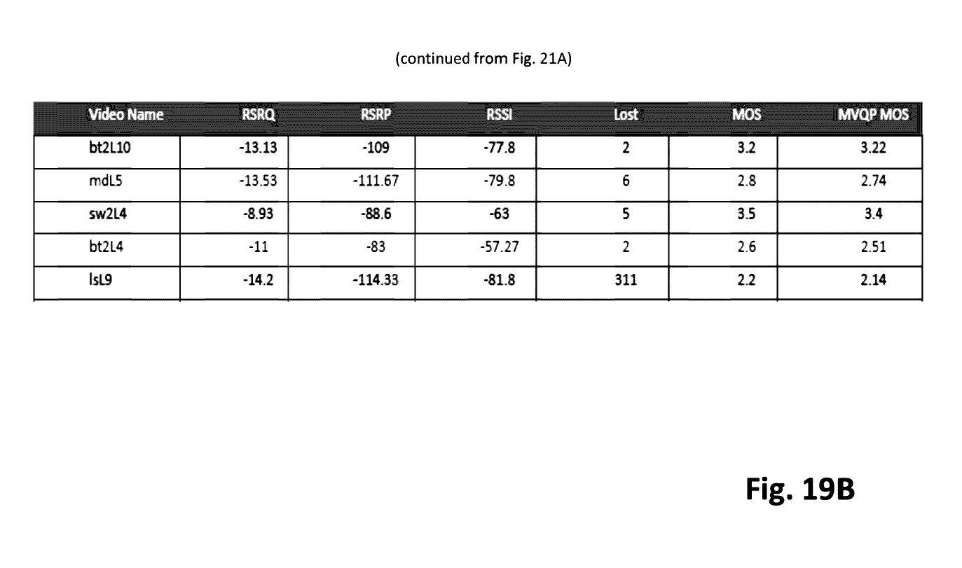

In step S1470, the MVQP is tested and validated. A set number of unknown data sets that were not used in the training process are used to test and validate the accuracy of the MVQP. FIGS. 19A-19B are a table illustrating exemplary testing sets that could be used to test the MVQP. If acceptable results are not achieved in step S1470, the process returns to step S1460 for additional training.

In step S1480, the MVQP is compared with human subjective MOS results. Experiments have shown the MVQP has a high correlation with the human subjective MOS.

FIG. 20 is an algorithmic flowchart 2200 illustrating the implementation of MVQP.

In step S2210, the inputs and target output are read from an external source, such as a text file.

In step S2215, the network parameters are initialized. Network parameters include, but are not limited to the number of neurons in the three layers of the RBF function, the learning rate (η), the stop condition error threshold, and the number of training cycles (epochs).

In step S2220, the center and the radius of each neuron are initialized.

In step S2225, the weights are initialized to a random number within a range of [−1, 1].

In step S2230, a random data set is chosen from a training set.

In step S2235, an output of the hidden layer is calculated as:

$$hiddenOutput = exp ( - \frac{\vert \vert input - center {\vert \vert}^{2}}{2 * {radius}^{2}} )$$

In step S2240, an output of the network is calculated as:

predictedOutput=bias+ΣhiddenOutput*weight

where a bias is a value associated with each node to allow a shift in the activation function to the right or to the left.

In step S2245, an error is calculated as:

error=targetOutput−predictedOutput

In step S2250, a hidden output weight is adjusted as:

newWeight=previousWeight−(η*error*hiddenOutput)

In step S2255, an average error is calculated.

In step S2260, it is determined whether a maximum number of training cycles has been reached. If the maximum number of training cycles has been reached (a “YES” decision in step S2260), the process ends. If the maximum number of training cycles has not been reached (a “NO” decision in step S2260), the process proceeds to step S2265.

In step S2265, it is determined whether an average error has exceeded a desired number. If the average error has not exceeded the desired number (a “NO” decision in step S2265), the process ends. If the average error has exceeded the desired number (a “YES” decision in step S2265), the process returns to step S2230.

The process of algorithmic flowchart 2200 continues until either the maximum number of training cycles has been reached or the average error has not exceeded the desired number.

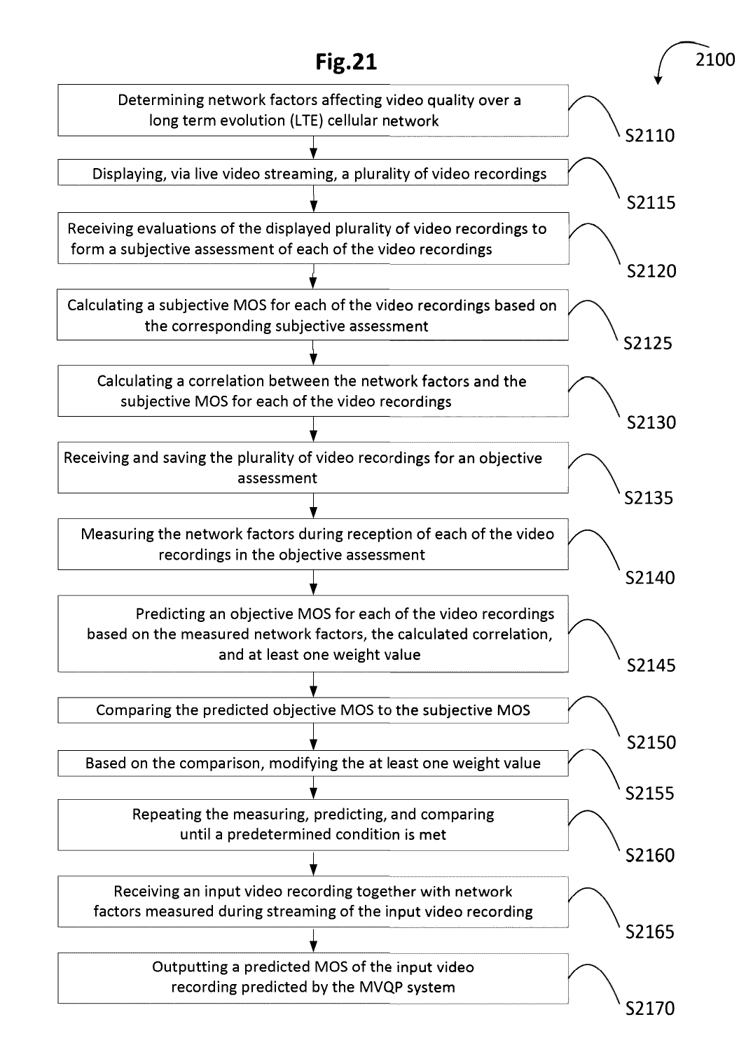

FIG. 21 is an algorithmic flowchart for a method 2100 of developing and testing a MVQP system. In step S2110, network factors that affect video quality over a LTE cellular network are determined. In step S2115, a plurality of video recordings is displayed, via live video streaming. In step S2120, evaluations of the displayed plurality of video recordings are received to form a subjective assessment of each of the video recordings. In step S2125, a subjective MOS is calculated for each of the video recordings based on the corresponding subjective assessment. In step S2130, a correlation between the network factors and the subjective MOS is calculated for each of the video recordings. Steps S2110 through S2130 constitute phase one of method 2100.

In step S2135, the plurality of video recordings is received and saved for an objective assessment. In step S2140, the network factors are measured during reception of each of the video recordings in the objective assessment. In step S2145, an objective MOS is predicted for each of the video recordings based on the measured network factors, the calculated correlation, and at least one weight value. In step S2150, the predicted objective MOS is compared to the subjective MOS. In step S2155, the at least one weight value is modified, based on the comparison. In step S2160, the measuring, predicting, and comparing are repeated until a predetermined condition is met. In step S2165, an input video recording is received together with network factors measured during streaming of the input video recording. In step S2170, a predicted MOS of the input video recording predicted by the MVQP system is outputted. Steps S2135 through S2170 constitute phase two of method 2100.

Embodiments described herein are a combination of hardware, software, and processing circuitry by which the software is implemented. Hardware and hardware/software combinations are described herein for exemplary purposes only.

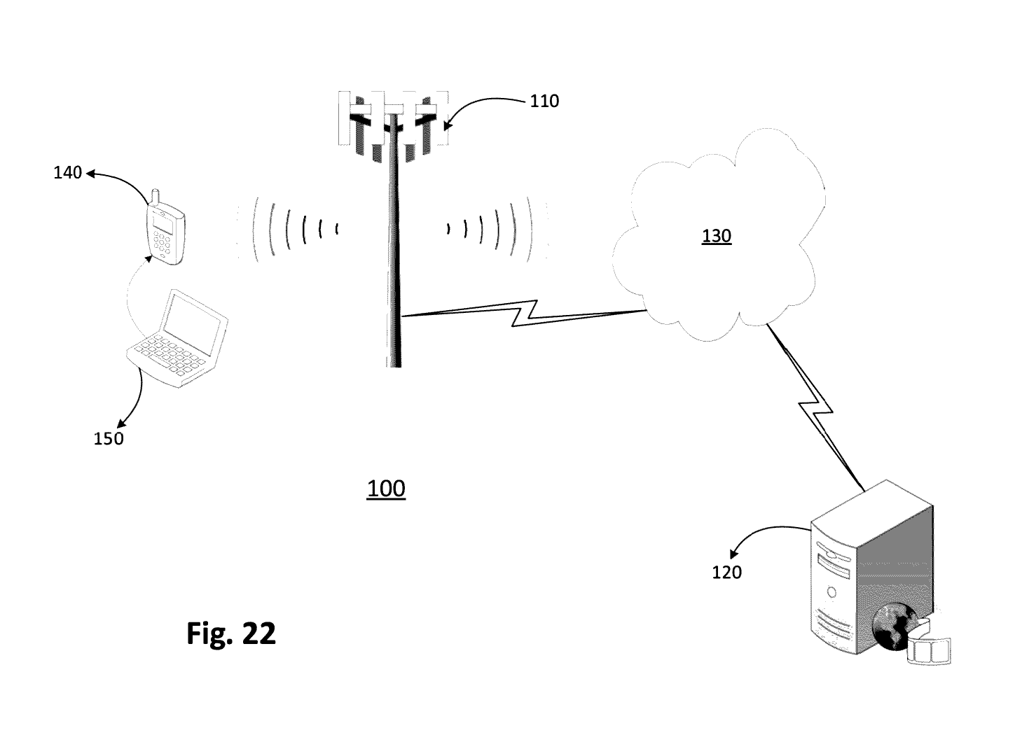

FIG. 22 illustrates an exemplary LTE network 100 in which video quality can be tested. LTE network 100 includes a base station 110 connected to a server 120 through the Internet 130. One or more user devices, such as a smart phone user device 140 and a laptop 150 are wirelessly connected to and registered with the base station 110.

Video quality measurements are obtained using LTE network 100. Video traffic is streamed over UDP using a MVQP streaming server 120. Signal measurements are stored in the laptop 150 and the MVQP server 120 for subsequent processing. The streaming video process captures raw videos, which are converted to MP4 and down sampled to flow into the LTE network 100.

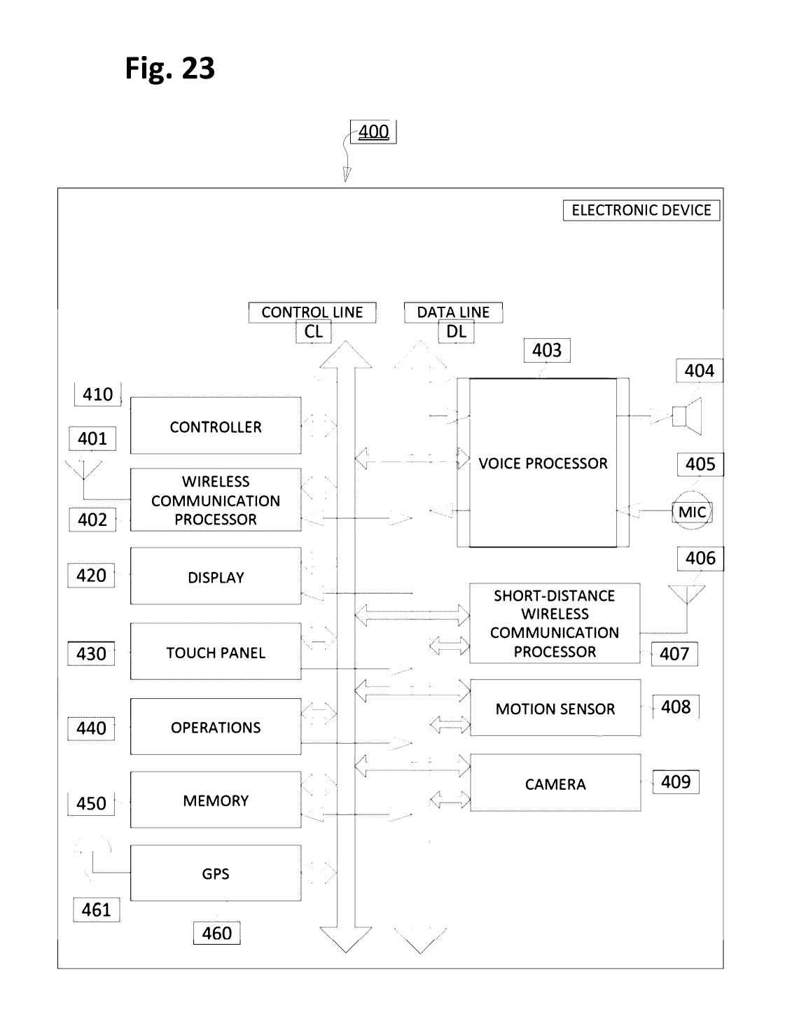

FIG. 23 is a block diagram illustrating an exemplary electronic device that could be used to implement one or more embodiments of the present disclosure. In some embodiments, electronic device 400 can be a smartphone, a laptop, a tablet, a server, an e-reader, a camera, a navigation device, etc. Electronic device 400 could be used as one or more of the mobile devices 140 or 150 in FIG. 22. The exemplary electronic device 400 of FIG. 4 includes a controller 410 and a wireless communication processor 402 connected to an antenna 401. A speaker 404 and a microphone 405 are connected to a voice processor 403.

The controller 410 can include one or more Central Processing Units (CPUs), and can control each element in the electronic device 400 to perform functions related to communication control, audio signal processing, control for the audio signal processing, still and moving image processing and control, and other kinds of signal processing. The controller 410 can perform these functions by executing instructions stored in a memory 450. Alternatively or in addition to the local storage of the memory 450, the functions can be executed using instructions stored on an external device accessed on a network or on a non-transitory computer readable medium.

The memory 450 includes but is not limited to Read Only Memory (ROM), Random Access Memory (RAM), or a memory array including a combination of volatile and non-volatile memory units. The memory 450 can be utilized as working memory by the controller 410 while executing the processes and algorithms of the present disclosure. Additionally, the memory 450 can be used for long-term storage, e.g., of image data and information related thereto.

The electronic device 400 includes a control line CL and data line DL as internal communication bus lines. Control data to/from the controller 410 can be transmitted through the control line CL. The data line DL can be used for transmission of voice data, display data, etc.

The antenna 401 transmits/receives electromagnetic wave signals between base stations for performing radio-based communication, such as the various forms of cellular telephone communication. The wireless communication processor 402 controls the communication performed between the electronic device 400 and other external devices via the antenna 401. For example, the wireless communication processor 402 can control communication between base stations for cellular phone communication.

The speaker 404 emits an audio signal corresponding to audio data supplied from the voice processor 403. The microphone 405 detects surrounding audio and converts the detected audio into an audio signal. The audio signal can then be output to the voice processor 403 for further processing. The voice processor 403 demodulates and/or decodes the audio data read from the memory 450 or audio data received by the wireless communication processor 402 and/or a short-distance wireless communication processor 407. Additionally, the voice processor 403 can decode audio signals obtained by the microphone 405.

The exemplary electronic device 400 can also include a display 420, a touch panel 430, an operations key 440, and a short-distance communication processor 407 connected to an antenna 406. The display 420 can be a Liquid Crystal Display (LCD), an organic electroluminescence display panel, or another display screen technology. In addition to displaying still and moving image data, the display 420 can display operational inputs, such as numbers or icons which can be used for control of the electronic device 400. The display 420 can additionally display a GUI for a user to control aspects of the electronic device 400 and/or other devices. Further, the display 420 can display characters and images received by the electronic device 400 and/or stored in the memory 450 or accessed from an external device on a network. For example, the electronic device 400 can access a network such as the Internet and display text and/or images transmitted from a Web server.

The touch panel 430 can include a physical touch panel display screen and a touch panel driver. The touch panel 430 can include one or more touch sensors for detecting an input operation on an operation surface of the touch panel display screen. The touch panel 430 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus can include a conductive material at least at the tip of the stylus, such that the sensors included in the touch panel 430 can detect when the stylus approaches/contacts the operation surface of the touch panel display (similar to the case in which a finger is used for the touch operation).

According to aspects of the present disclosure, the touch panel 430 can be disposed adjacent to the display 420 (e.g., laminated) or can be formed integrally with the display 420. For simplicity, the present disclosure assumes the touch panel 430 is formed integrally with the display 420 and therefore, examples discussed herein can describe touch operations being performed on the surface of the display 420 rather than the touch panel 430. However, the skilled artisan will appreciate that this is not limiting.

For simplicity, the present disclosure assumes the touch panel 430 is a capacitance-type touch panel technology. However, it should be appreciated that aspects of the present disclosure can easily be applied to other touch panel types (e.g., resistance-type touch panels) with alternate structures. According to aspects of the present disclosure, the touch panel 430 can include transparent electrode touch sensors arranged in the X-Y direction on the surface of transparent sensor glass.

The touch panel driver can be included in the touch panel 430 for control processing related to the touch panel 430, such as scanning control. For example, the touch panel driver can scan each sensor in an electrostatic capacitance transparent electrode pattern in the X-direction and Y-direction and detect the electrostatic capacitance value of each sensor to determine when a touch operation is performed. The touch panel driver can output a coordinate and corresponding electrostatic capacitance value for each sensor. The touch panel driver can also output a sensor identifier that can be mapped to a coordinate on the touch panel display screen. Additionally, the touch panel driver and touch panel sensors can detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. Signals can be transmitted by the touch panel driver, e.g. in response to a detection of a touch operation, in response to a query from another element based on timed data exchange, etc.

The touch panel 430 and the display 420 can be surrounded by a protective casing, which can also enclose the other elements included in the electronic device 400. According to aspects of the disclosure, a position of the user's fingers on the protective casing (but not directly on the surface of the display 420) can be detected by the touch panel 430 sensors. Accordingly, the controller 410 can perform display control processing described herein based on the detected position of the user's fingers gripping the casing. For example, an element in an interface can be moved to a new location within the interface (e.g., closer to one or more of the fingers) based on the detected finger position.

Further, according to aspects of the disclosure, the controller 410 can be configured to detect which hand is holding the electronic device 400, based on the detected finger position. For example, the touch panel 430 sensors can detect a plurality of fingers on the left side of the electronic device 400 (e.g., on an edge of the display 420 or on the protective casing), and detect a single finger on the right side of the electronic device 400. In this exemplary scenario, the controller 410 can determine that the user is holding the electronic device 400 with his/her right hand because the detected grip pattern corresponds to an expected pattern when the electronic device 400 is held only with the right hand.

The operation key 440 can include one or more buttons or similar external control elements, which can generate an operation signal based on a detected input by the user. In addition to outputs from the touch panel 430, these operation signals can be supplied to the controller 410 for performing related processing and control. According to aspects of the disclosure, the processing and/or functions associated with external buttons and the like can be performed by the controller 410 in response to an input operation on the touch panel 430 display screen rather than the external button, key, etc. In this way, external buttons on the electronic device 400 can be eliminated in lieu of performing inputs via touch operations, thereby improving water-tightness.

The antenna 406 can transmit/receive electromagnetic wave signals to/from other external apparatuses, and the short-distance wireless communication processor 407 can control the wireless communication performed between the other external apparatuses. Bluetooth, IEEE 802.11, and near-field communication (NFC) are non-limiting examples of wireless communication protocols that can be used for inter-device communication via the short-distance wireless communication processor 407.

The electronic device 400 can include a motion sensor 408. The motion sensor 408 can detect features of motion (i.e., one or more movements) of the electronic device 400. For example, the motion sensor 408 can include an accelerometer to detect acceleration, a gyroscope to detect angular velocity, a geomagnetic sensor to detect direction, a geo-location sensor to detect location, etc., or a combination thereof to detect motion of the electronic device 400. According to aspects of the disclosure, the motion sensor 408 can generate a detection signal that includes data representing the detected motion. For example, the motion sensor 408 can determine a number of distinct movements in a motion (e.g., from start of the series of movements to the stop, within a predetermined time interval, etc.), a number of physical shocks on the electronic device 400 (e.g., a jarring, hitting, etc., of the electronic device 400), a speed and/or acceleration of the motion (instantaneous and/or temporal), or other motion features. The detected motion features can be included in the generated detection signal. The detection signal can be transmitted, e.g., to the controller 410, whereby further processing can be performed based on data included in the detection signal. The motion sensor 408 can work in conjunction with a Global Positioning System (GPS) 460. The GPS 460 detects the present position of the electronic device 400. The information of the present position detected by the GPS 460 is transmitted to the controller 410. An antenna 461 is connected to the GPS 460 for receiving and transmitting signals to and from a GPS satellite.

Electronic device 400 can include a camera 409, which includes a lens and shutter for capturing photographs of the surroundings around the electronic device 400. In an embodiment, the camera 409 captures surroundings of an opposite side of the electronic device 400 from the user. The images of the captured photographs can be displayed on the display panel 420. A memory saves the captured photographs. The memory can reside within the camera 409 or it can be part of the memory 450. The camera 409 can be a separate feature attached to the electronic device 400 or it can be a built-in camera feature.

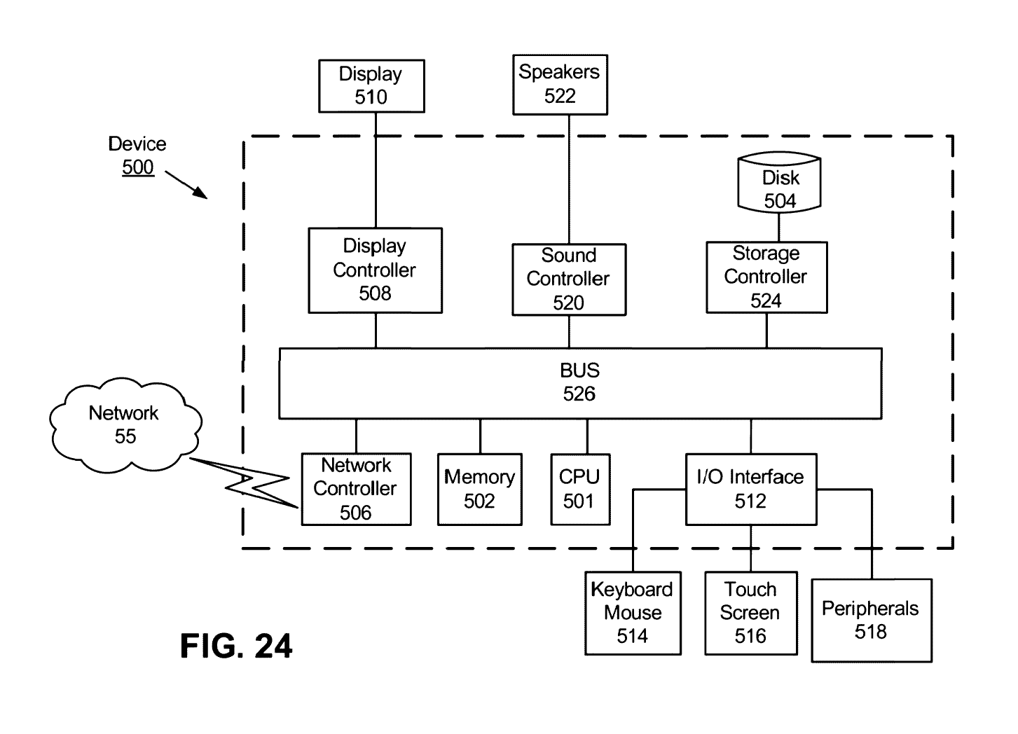

A hardware description of a computing device 500 used in accordance with exemplary embodiments is described with reference to FIG. 24. One or more features described above with reference to electronic device 400 of FIG. 23 can be included in computing device 500 described below. Computing device 500 could be used as server 120 of FIG. 22.

In FIG. 24, the computing device includes a CPU 501 which performs the processes described herein. The process data and instructions may be stored in memory 502. These processes and instructions may also be stored on a storage medium disk 504 such as a hard drive (HDD) or portable storage medium or may be stored remotely. Further, the claimed embodiments are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claimed embodiments may be provided as a utility application, background daemon, or component of an operating system, or combination thereof, executing in conjunction with CPU 501 and an operating system such as Microsoft Windows, UNIX, Solaris, LINUX, Apple MAC-OS and other systems known to those skilled in the art.

CPU 501 may be a Xenon or Core processor from Intel of America or an Opteron processor from AMD of America, or may be other processor types that would be recognized by one of ordinary skill in the art. Alternatively, the CPU 501 may be implemented on an FPGA, ASIC, PLD or using discrete logic circuits, as one of ordinary skill in the art would recognize. Further, CPU 501 may be implemented as multiple processors cooperatively working in parallel to perform the instructions of the inventive processes described above.

The computing device 500 in FIG. 24 also includes a network controller 506, such as an Intel Ethernet PRO network interface card from Intel Corporation of America, for interfacing with network 55. As can be appreciated, the network 55 can be a public network, such as the Internet, or a private network such as an LAN or WAN network, or any combination thereof and can also include PSTN or ISDN sub-networks. The network 55 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device 500 further includes a display controller 508, such as a NVIDIA GeForce GTX or Quadro graphics adaptor from NVIDIA Corporation of America for interfacing with display 510, such as a Hewlett Packard HPL2445w LCD monitor. A general purpose I/O interface 512 interfaces with a keyboard and/or mouse 514 as well as a touch screen panel 516 on or separate from display 510. General purpose I/O interface 512 also connects to a variety of peripherals 518 including printers and scanners, such as an OfficeJet or DeskJet from Hewlett Packard.

A sound controller 520 is also provided in the computing device, such as Sound Blaster X-Fi Titanium from Creative, to interface with speakers/microphone 522 thereby providing sounds and/or music.

The general purpose storage controller 524 connects the storage medium disk 504 with communication bus 526, which may be an ISA, EISA, VESA, PCI, or similar, for interconnecting all of the components of the computing device 500. A description of the general features and functionality of the display 510, keyboard and/or mouse 514, as well as the display controller 508, storage controller 524, network controller 506, sound controller 520, and general purpose I/O interface 512 is omitted herein for brevity.

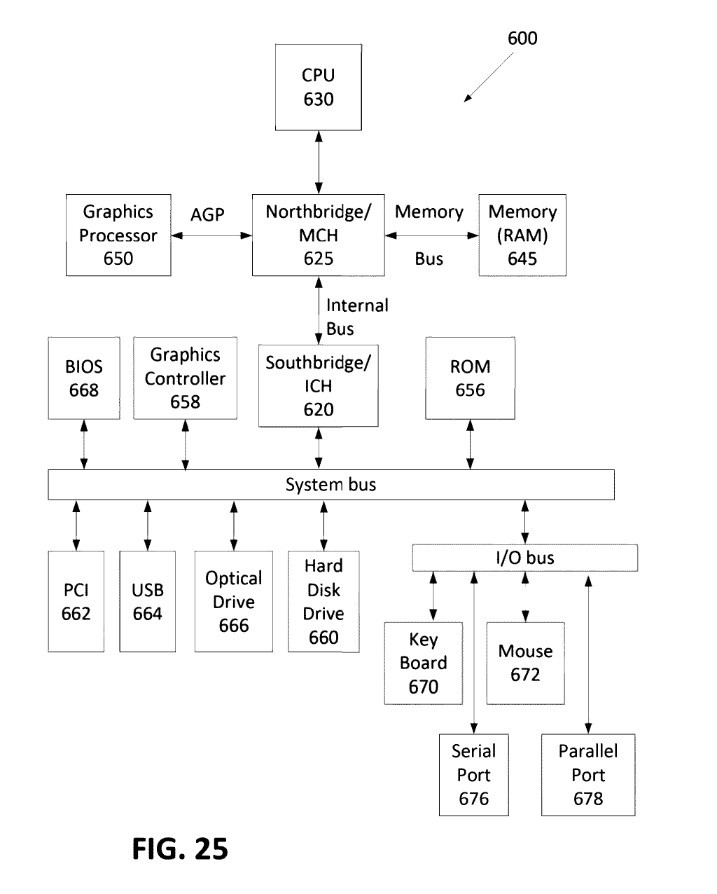

The exemplary circuit elements described in the context of the present disclosure can be replaced with other elements and structured differently than the examples provided herein. Moreover, circuitry configured to perform features described herein can be implemented in multiple circuit units (e.g., chips), or the features can be combined in circuitry on a single chipset, as shown in FIG. 25. The chipset of FIG. 25 can be implemented in conjunction with either electronic device 400 or computing device 500 described above with reference to FIGS. 23 and 24, respectively.

FIG. 25 is a schematic diagram of a data processing system, according to aspects of the disclosure described herein for performing menu navigation, as described above. The data processing system is an example of a computer in which code or instructions implementing the processes of the illustrative embodiments can be located.

In FIG. 25, data processing system 600 employs an application architecture including a north bridge and memory controller hub (NB/MCH) 625 and a south bridge and input/output (I/O) controller hub (SB/ICH) 620. The central processing unit (CPU) 630 is connected to NB/MCH 625. The NB/MCH 625 also connects to the memory 645 via a memory bus, and connects to the graphics processor 650 via an accelerated graphics port (AGP). The NB/MCH 625 also connects to the SB/ICH 620 via an internal bus (e.g., a unified media interface or a direct media interface). The CPU 630 can contain one or more processors and even can be implemented using one or more heterogeneous processor systems.

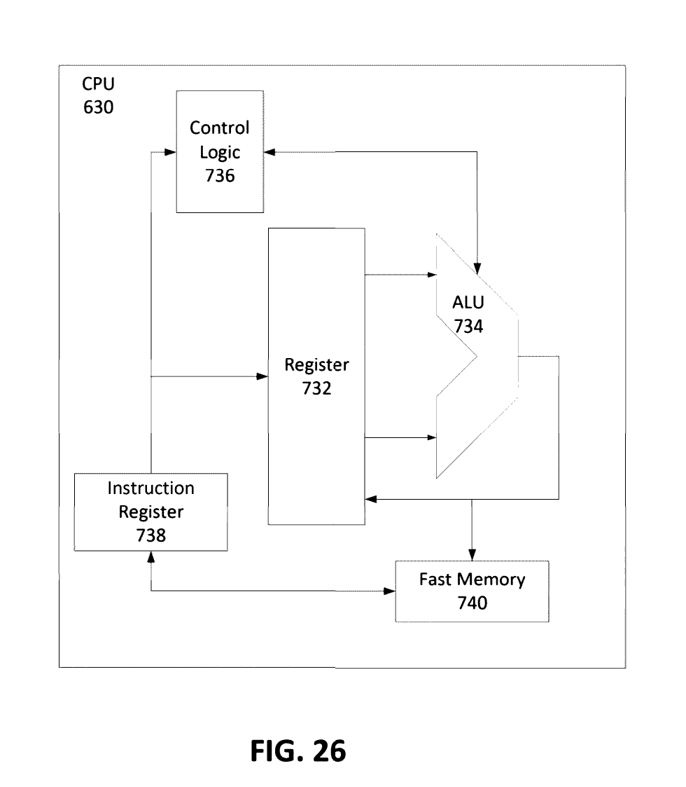

For example, FIG. 26 is a block diagram illustrating an implementation of CPU 630. In one implementation, an instruction register 738 retrieves instructions from a fast memory 740. At least part of these instructions are fetched from an instruction register 738 by a control logic 736 and interpreted according to the instruction set architecture of the CPU 630. Part of the instructions can also be directed to a register 732. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using an arithmetic logic unit (ALU) 734 that loads values from the register 732 and performs logical and mathematical operations on the loaded values according to the instructions. The results from these operations can be fed back into the register 732 and/or stored in a fast memory 740. According to aspects of the disclosure, the instruction set architecture of the CPU 630 can use a reduced instruction set computer (RISC), a complex instruction set computer (CISC), a vector processor architecture, or a very long instruction word (VLIW) architecture. Furthermore, the CPU 630 can be based on the Von Neuman model or the Harvard model. The CPU 630 can be a digital signal processor, an FPGA, an ASIC, a PLA, a PLD, or a CPLD. Further, the CPU 630 can be an x86 processor by Intel or by AMD; an ARM processor; a Power architecture processor by, e.g., IBM; a SPARC architecture processor by Sun Microsystems or by Oracle; or other known CPU architectures.

Referring again to FIG. 25, the data processing system 600 can include the SB/ICH 620 being coupled through a system bus to an I/O Bus, a read only memory (ROM) 656, universal serial bus (USB) port 664, a flash binary input/output system (BIOS) 668, and a graphics controller 658. PCI/PCIe devices can also be coupled to SB/ICH 620 through a PCI bus 662.

The PCI devices can include, for example, Ethernet adapters, add-in cards, and PC cards for notebook computers. The Hard disk drive 660 and CD-ROM 666 can use, for example, an integrated drive electronics (IDE) or serial advanced technology attachment (SATA) interface. In one implementation the I/O bus can include a super I/O (SIO) device.

Further, the hard disk drive (HDD) 660 and optical drive 666 can also be coupled to the SB/ICH 620 through a system bus. In one implementation, a keyboard 670, a mouse 672, a parallel port 678, and a serial port 676 can be connected to the system bus through the I/O bus. Other peripherals and devices can be connected to the SB/ICH 620 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein can also be executed by various distributed components of a system. For example, one or more processors can execute these system functions, wherein the processors are distributed across multiple components communicating in a network. The distributed components can include one or more client and server machines, which can share processing, such as a cloud computing system, in addition to various human interface and communication devices (e.g., display monitors, smart phones, tablets, personal digital assistants (PDAs)). The network can be a private network, such as a LAN or WAN, or can be a public network, such as the Internet. Input to the system can be received via direct user input and received remotely either in real-time or as a batch process. Additionally, some implementations can be performed on modules or hardware not identical to those described. Accordingly, other implementations are within the scope that can be claimed.

The functions and features described herein may also be executed by various distributed components of a system. For example, one or more processors may execute these system functions, wherein the processors are distributed across multiple components communicating in a network. For example, distributed performance of the processing functions can be realized using grid computing or cloud computing. Many modalities of remote and distributed computing can be referred to under the umbrella of cloud computing, including: software as a service, platform as a service, data as a service, and infrastructure as a service. Cloud computing generally refers to processing performed at centralized locations and accessible to multiple users who interact with the centralized processing locations through individual terminals.

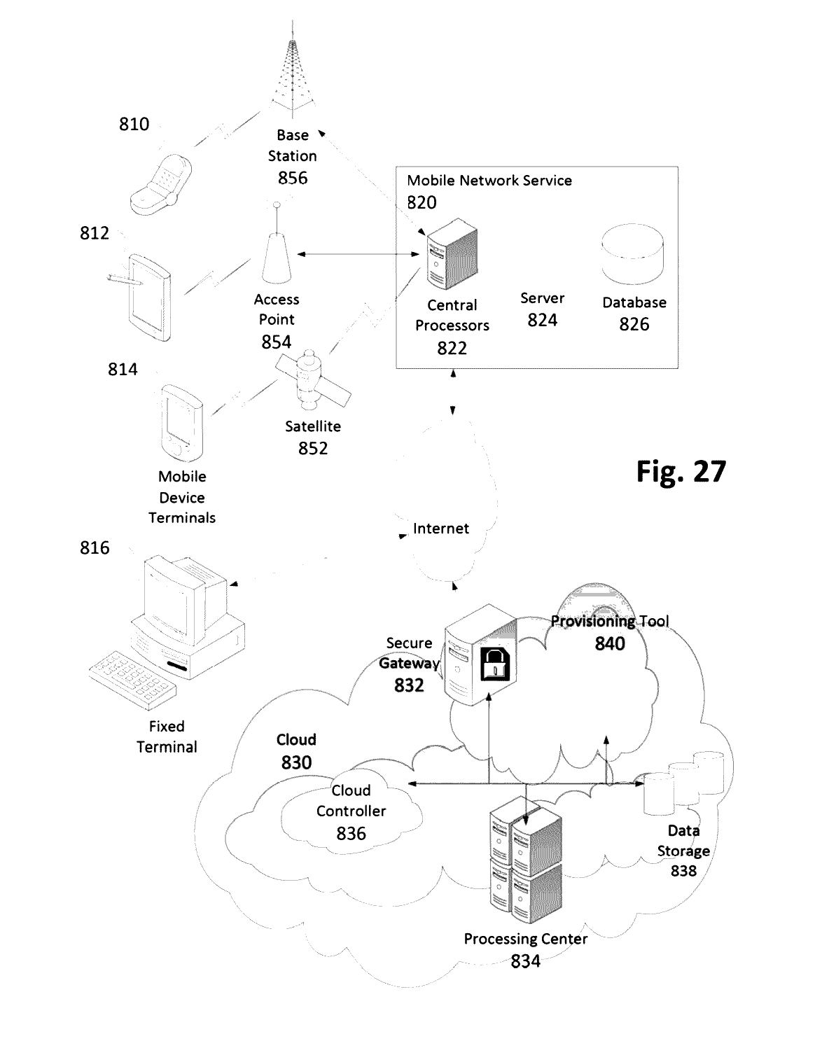

FIG. 27 illustrates an exemplary cloud computing system 800, wherein users access the cloud through mobile device terminals or fixed terminals that are connected to the Internet. One or more of the devices illustrated as server 120 and mobile devices 140 and 150 could be used in the cloud computing system 800 illustrated in FIG. 28.

The mobile device terminals can include a cell phone 810, a tablet computer 812, and a smartphone 814, for example. The mobile device terminals can connect to a mobile network service 820 through a wireless channel such as a base station 856 (e.g., an Edge, 3G, 4G, or LTE Network), an access point 854 (e.g., a femto cell or WiFi network), or a satellite connection 852. In one implementation, signals from the wireless interface to the mobile device terminals (e.g., the base station 856, the access point 854, and the satellite connection 852) are transmitted to a mobile network service 820, such as an eNodeB and radio network controller, UMTS, or HSDPA/HSUPA. Mobile users' requests and information are transmitted to central processors 822 that are connected to servers 824 to provide mobile network services, for example. Further, mobile network operators can provide service to mobile users for authentication, authorization, and accounting based on home agent and subscribers' data stored in databases 826, for example. The subscribers' requests are subsequently delivered to a cloud 830, such as cloud 130 of FIG. 1 through the Internet.

A user can also access the cloud 830 through a fixed terminal 816, such as a desktop or laptop computer or workstation that is connected to the Internet via a wired network connection or a wireless network connection. The mobile network service 820 can be a public or a private network such as an LAN or WAN network. The mobile network service 820 can be wireless such as a cellular network including EDGE, 3G and 4G wireless cellular systems. The wireless mobile network service 820 can also be Wi-Fi, Bluetooth, or any other wireless form of communication that is known.

The user's terminal, such as a mobile user terminal and a fixed user terminal, provides a mechanism to connect via the Internet to the cloud 830 and to receive output from the cloud 830, which is communicated and displayed at the user's terminal. In the cloud 830, a cloud controller 836 processes the request to provide users with the corresponding cloud services. These services are provided using the concepts of utility computing, virtualization, and service-oriented architecture.

In one implementation, the cloud 830 is accessed via a user interface such as a secure gateway 832. The secure gateway 832 can for example, provide security policy enforcement points placed between cloud service consumers and cloud service providers to interject enterprise security policies as the cloud-based resources are accessed. Further, the secure gateway 832 can consolidate multiple types of security policy enforcement, including for example, authentication, single sign-on, authorization, security token mapping, encryption, tokenization, logging, alerting, and API control. The cloud 830 can provide to users, computational resources using a system of virtualization, wherein processing and memory requirements can be dynamically allocated and dispersed among a combination of processors and memories to create a virtual machine that is more efficient at utilizing available resources. Virtualization creates an appearance of using a single seamless computer, even though multiple computational resources and memories can be utilized according to increases or decreases in demand. In one implementation, virtualization is achieved using a provisioning tool 840 that prepares and equips the cloud resources, such as the processing center 834 and data storage 838 to provide services to the users of the cloud 830. The processing center 834 can be a computer cluster, a data center, a main frame computer, or a server farm. In one implementation, the processing center 834 and data storage 838 are collocated.

Embodiments herein describe systems and methods of predicting video quality over a LTE network automatically, using artificial intelligence. In phase one, a subjective human assessment is made in which video quality is evaluated, such as a rating from one to five. For example, if video A is played and the video quality is very good, it should receive a rating between four and five. If the video quality is bad, it should receive a rating between one and two. A subjective MOS is calculated from the ratings.

The data from phase one is saved and used to train the MVQP system. At this point, there is no need for human intervention to predict video quality. The trained MVQP system will automatically predict the quality of subsequent video streaming in an objective assessment.

The above disclosure also encompasses the aspects listed below.

(1) A MVQP system includes a first processing circuitry configured to develop a subjective video assessment. The first processing circuitry is configured to determine network factors affecting video quality over a LTE cellular network; display, via live video streaming, a plurality of video recordings; measure the network factors corresponding to each of the plurality of streamed video recordings; receive evaluations of the displayed plurality of video recordings to form a subjective assessment of each of the video recordings; calculate a subjective MOS for each of the video recordings based on the corresponding subjective assessment; and calculate a correlation between the measured network factors and the subjective MOS for each of the video recordings. The MVQP system also includes second processing circuitry configured to train the MVQP system. The second processing circuitry is configured to receive and save the plurality of video recordings; measure the network factors during reception of each of the video recordings; predict an output MOS for each of the video recordings based on the measured network factors, the calculated correlation, and at least one weight value; compare the predicted output MOS to the subjective MOS based on the subjective assessment; based on the comparison, modify the at least one weight value; and repeat the measuring, predicting, and comparing until a predetermined condition is met. The MVQP system also includes third processing circuitry configured to receive an input video recording together with network factors measured during streaming of the input video recording and output a MOS predicted for the input video recording by the MVQP system.

(2) The MVQP system of (1), wherein the measuring, predicting, and comparing comprise a training cycle.

(3) The MVQP system of either (1) or (2), wherein the predicting includes calculating an output of a hidden layer of a RBF ANN.

(4) The MVQP system of any one of (1) through (3), wherein the subjective MOS is a function of the network factors and calculated packets lost.

(5) The MVQP system of any one of (1) through (4), wherein the network factors include at least one of a RSSI, a RSRP, and a RSRQ.

(6) The MVQP system of any one of (1) through (5), wherein the network factors include the RSRQ, which is equivalent to a ratio of the RSRP to the RSSI multiplied by a number of resource blocks used for the RSSI.

(7) The MVQP system of any one of (1) through (6), wherein the live video streaming is over a UDP through the LTE cellular network.

(8) The MVQP system of any one of (1) through (7), wherein the first processing circuitry is further configured to receive streaming video from a server, display the received streaming video via a mobile device, and receive the evaluations during the streaming.

(9) A method of developing and testing a MVQP system, the method including determining network factors affecting video quality over a LTE cellular network; displaying, via live video streaming, a plurality of video recordings; receiving evaluations of the displayed plurality of video recordings to form a subjective assessment of each of the video recordings; calculating a subjective MOS for each of the video recordings based on the corresponding subjective assessment; calculating a correlation between the network factors and the subjective MOS for each of the video recordings; receiving and saving the plurality of video recordings for an objective assessment; measuring the network factors during reception of each of the video recordings in the objective assessment; predicting an objective MOS for each of the video recordings based on the measured network factors, the calculated correlation, and at least one weight value; comparing the predicted objective MOS to the subjective MOS; based on the comparison, modifying the at least one weight value; repeating the measuring, predicting, and comparing until a predetermined condition is met; receiving an input video recording together with network factors measured during streaming of the input video recording; and outputting a predicted MOS of the input video recording predicted by the MVQP system.

(10) The method of (9), wherein the network factors include one or more of a RSSI, a RSRP, and a RSRQ.

(11) The method of either (9) or (10), wherein the measuring, predicting, and comparing comprise at least one training cycle.

(12) The method of any one of (9) through (11), wherein the predetermined condition is a maximum number of training cycles having been reached.

(13) The method of any one of (9) through (12), wherein the predetermined condition is an average error between the predicted objective MOS and the subjective MOS being below a predetermined number.

(14) The method of any one of (9) through (13), wherein the predicting includes calculating an output of a hidden layer of a RBF ANN.

(15) A non-transitory computer-readable medium having computer-executable instructions embodied thereon, that when executed by a computing device, performs a MVQP method, the MVQP method including determining network factors affecting video quality over a LTE cellular network, wherein the network factors include at least one of a RSSI, a RSRP, and a RSRQ; displaying, via live video streaming, a plurality of video recordings from a server of the LTE cellular network to a mobile device; receiving observer ratings of the displayed plurality of video recordings to form a subjective assessment of each of the video recordings; calculating a subjective MOS for each of the video recordings based on the corresponding subjective assessment, wherein the subjective MOS is a function of the network factors and a calculation of lost packets; calculating a correlation between the network factors and the subjective MOS for each of the video recordings; receiving and saving the plurality of video recordings for an objective assessment; measuring the network factors during reception of each of the video recordings in the objective assessment; predicting an objective MOS for each of the video recordings based on the measured network factors, the calculated correlation, and at least one weight value; comparing the predicted objective MOS to the subjective MOS; based on the comparison, modifying the at least one weight value; repeating the measuring, predicting, and comparing until a predetermined condition is met; receiving an input video recording together with network factors measured during streaming of the input video recording; and outputting a predicted MOS of the input video recording predicted by the MVQP system.

(16) The non-transitory computer-readable medium of (15), wherein the measuring in the objective assessment is executed in a background of a MVQP system simultaneously while the receiving in the objective assessment is executed in a front-end of the MVQP system.

(17) The non-transitory computer-readable medium of either (15) or (16), wherein the predicting includes calculating an output of a hidden layer of a RBF ANN.

Embodiments described herein provide a prediction system and method for mobile video quality, which achieves a high correlation with human subjective MOS results. The effects of radio frequency parameters on live video streaming over a live LTE cellular network can be analyzed. The analysis can assist RF engineers in evaluating the cellular network and adjust parameters accordingly to provide better service.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure is intended to be illustrative, but not limiting of the scope of the claims. The disclosure, including any readily discernible variants of the teachings herein, defines in part, the scope of the foregoing claim terminology, such that no subject matter is dedicated to the public.

1. A mobile video quality prediction (MVQP) system, comprising:
first processing circuitry configured to develop a subjective video assessment, the first processing circuitry being configured to
determine network factors affecting video quality over a long term evolution (LTE) cellular network,
display, via live video streaming, a plurality of video recordings,
measure the network factors corresponding to each of the plurality of streamed video recordings,
receive evaluations of the displayed plurality of video recordings to form a subjective assessment of each of the video recordings,
calculate a subjective mean opinion score (MOS) for each of the video recordings based on the corresponding subjective assessment, and
calculate a correlation between the measured network factors and the subjective MOS for each of the video recordings;
second processing circuitry configured to train the MVQP system, the second processing circuitry configured to
receive and save the plurality of video recordings,
measure the network factors during reception of each of the video recordings,
predict an output MOS for each of the video recordings based on the measured network factors, the calculated correlation, and at least one weight value,
compare the predicted output MOS to the subjective MOS based on the subjective assessment,
based on the comparison, modify the at least one weight value, and
repeat the measuring, predicting, and comparing until a predetermined condition is met; and
third processing circuitry configured to receive an input video recording together with network factors measured during streaming of the input video recording and output a MOS predicted for the input video recording by the MVQP system.

2. The MVQP system of claim 1, wherein the measuring, predicting, and comparing comprise a training cycle.

3. The MVQP system of claim 2, wherein the
predicting includes calculating an output of a hidden layer of a Radial Basis Function (RBF) artificial neural network (ANN.

4. The MVQP system of claim 1, wherein the subjective MOS is a function of the network factors and calculated packets lost.

5. The MVQP system of claim 4, wherein the network factors include at least one of a Reference Signal Strength Indicator (RSSI), a Reference Signal Received Power (RSRP), and a Reference Signal Received Quality (RSRQ).

6. The MVQP system of claim 5, wherein the network factors include the RSRQ, which is equivalent to a ratio of the RSRP to the RSSI multiplied by a number of resource blocks used for the RSSI.

7. The MVQP system of claim 1, wherein the live video streaming is over a User Diagram Protocol (UDP) through the LTE cellular network.

8. The MVQP system of claim 1, wherein the first processing circuitry is further configured to
receive streaming video from a server,
display the received streaming video via a mobile device, and
receive the evaluations during the streaming.

9. A method of developing and testing a mobile video quality prediction (MVQP) system, the method comprising:
determining network factors affecting video quality over a long term evolution (LTE) cellular network;
displaying, via live video streaming, a plurality of video recordings;
receiving evaluations of the displayed plurality of video recordings to form a subjective assessment of each of the video recordings;
calculating a subjective mean opinion score (MOS) for each of the video recordings based on the corresponding subjective assessment;
calculating a correlation between the network factors and the subjective MOS for each of the video recordings;
receiving and saving the plurality of video recordings for an objective assessment;
measuring the network factors during reception of each of the video recordings in the objective assessment;
predicting an objective MOS for each of the video recordings based on the measured network factors, the calculated correlation, and at least one weight value;
comparing the predicted objective MOS to the subjective MOS;
based on the comparison, modifying the at least one weight value;
repeating the measuring, predicting, and comparing until a predetermined condition is met;
receiving an input video recording together with network factors measured during streaming of the input video recording; and
outputting a predicted MOS of the input video recording predicted by the MVQP system.

10. The method of claim 9, wherein the network factors include one or more of a Reference Signal Strength Indicator (RSSI), a Reference Signal Received Power (RSRP), and a Reference Signal Received Quality (RSRQ).

11. The method of claim 9, wherein the measuring, predicting, and comparing comprise at least one training cycle.

12. The method of claim 11, wherein the predetermined condition is a maximum number of training cycles having been reached.

13. The method of claim 11, wherein the predetermined condition is an average error between the predicted objective MOS and the subjective MOS being below a predetermined number.

14. The method of claim 9, wherein the predicting includes calculating an output of a hidden layer of a Radial Basis Function (RBF) artificial neural network (ANN).

15. A non-transitory computer-readable medium having computer-executable instructions embodied thereon, that when executed by a computing device, performs a mobile video quality prediction (MVQP) method, the MVQP method comprising:
determining network factors affecting video quality over a long term evolution (LTE) cellular network, wherein the network factors include at least one of a Reference Signal Strength Indicator (RSSI), a Reference Signal Received Power (RSRP), and a Reference Signal Received Quality (RSRQ);
displaying, via live video streaming, a plurality of video recordings from a server of the LTE cellular network to a mobile device;
receiving observer ratings of the displayed plurality of video recordings to form a subjective assessment of each of the video recordings;
calculating a subjective mean opinion score (MOS) for each of the video recordings based on the corresponding subjective assessment, wherein the subjective MOS is a function of the network factors and a calculation of lost packets;
calculating a correlation between the network factors and the subjective MOS for each of the video recordings;
receiving and saving the plurality of video recordings for an objective assessment;
measuring the network factors during reception of each of the video recordings in the objective assessment;
predicting an objective MOS for each of the video recordings based on the measured network factors, the calculated correlation, and at least one weight value;
comparing the predicted objective MOS to the subjective MOS;
based on the comparison, modifying the at least one weight value;
repeating the measuring, predicting, and comparing until a predetermined condition is met;
receiving an input video recording together with network factors measured during streaming of the input video recording; and
outputting a predicted MOS of the input video recording predicted by the MVQP system.

16. The non-transitory computer-readable medium of claim 15, wherein the measuring in the objective assessment is executed in a background of a MVQP system simultaneously while the receiving in the objective assessment is executed in a front-end of the MVQP system.

17. The non-transitory computer-readable medium of claim 15, wherein the predicting includes calculating an output of a hidden layer of a Radial Basis Function (RBF) artificial neural network (ANN).
